(19) United States
(12) Patent Application Publication
(10) Pub. No.: US 2003/0109296 A1
(43) Pub. Date: Jun. 12, 2003

(54) Generation method

(76) Inventors: Gary Mark Leach, Manchester (GB); Huw Meredydd Lloyd, Newton Le Willows (GB)

Correspondence Address: Pillsbury Winthrop LLP, Intellectual Property Group, Suite 2800, 725 South Figueroa Street, Los Angeles, CA, 90017-5406, US

(21) Appl. No.: 10/055,727

(22) Filed: Jan. 23, 2002

(30) Foreign Application Priority Data
Nov. 15, 2001 (GB) 0127397.8

(51) Int. Cl. G06F 17/00

(52) U.S. Cl. 463/6

(57) ABSTRACT

A method for generating a representation of a track which is to be followed through a virtual space. A path is steered through the space, track path data representing the path is stored, and the track is established to follow that path. The track may be manipulated by selecting at least two points on the track, and applying a predetermined effect to the track between the two selected points. Navigational instructions may be generated which if obeyed will allow a vehicle to follow a route about a previously established track. Track geometry is determined by looking ahead along the track in the direction of travel, and instructions are derived in response to the determined track geometry.

The present invention relates to a method and apparatus for generating a representation of a track, and more particularly to such a method and apparatus suitable for use in a computer implemented game. The present invention also relates to a method and apparatus for manipulating a track to be followed, and a method for producing navigational instructions to follow such a track.

The increased ubiquity of consumer electronics has affected very many aspects of everyday life. Computer games now provide a popular pastime for both children and adults. Such games cover a wide range of topics including games based upon a particular sport, games based upon martial arts, games based upon strategy, games based upon movement about an imaginary world and games involving the racing of vehicles. There are also a large number of other game types in common use.

Such games can either be operated on a dedicated computer games console or on a personal computer. Use of a dedicated console may improve game performance, as the hardware may be optimised for the vector graphics intensive operations upon which modern computer games are heavily reliant. However, use of a personal computer avoids purchasing of specific hardware.

Computer games consoles are widely available. Some of the most popular include the Sony PlayStation.2, the Nintendo Game Cube, and Microsoft X-BOX. All consoles share the same basic functionality, but vary in terms of the detailed hardware specification.

Racing games are one of the most popular of the game types identified above. Typically, in racing games, a user races either against opponents or against the clock. Game creators expend considerable effort in creating novel ways of making their products appealing to users given the strong competition that is present in the marketplace.

A known racing game offers users a feature whereby a track may be created from a number of predefined building blocks. For example, a user may be presented with straight sections, right bends and left bends which can be combined to form different track layouts. Having created a track from these predefined building blocks a user may then use this track as the basis for a race, once it has been converted into an appropriate format for display in the game.

The game described above has a number of disadvantages. As a track can be built only from a combination of predefined building blocks, only a relatively limited number of tracks may be created. The track is created using a different representation to that used for the race, and a potentially complex translation between the two formats is required. Furthermore, the track creation display used by the game is different to that used when the track is raced. Creation is effected using schematic illustrations of the various segments, and image rendering is applied only during a race. Thus it is difficult for a user to visualise how the completed track will appear on screen.

It is an object of a first aspect and of a second aspect of the present invention to obviate or mitigate one or more of the problems outlined above.

According to a first aspect of the present invention, there is provided a method for generating a representation of a track which is to be followed through a virtual space, wherein a path is steered through the space, track path data representing the path is stored, and the track is established to follow that path.

According to a second aspect of the present invention, there is provided a track generator for generating a representation of a track which is to be followed through a virtual space, comprising means for steering a path through the space, means for storing track path data representing the path, and means for establishing the track to follow that path.

A portion of a previously established track from which a branch track is to be established may be selected and a branch track path may be steered through the space from the selected portion of the previously established track. Track path data representing the branch track path may be stored, and the branch track may be established to follow that branch track path.

Preferably, if a path is steered which comes within a predetermined distance of a previously established track, updated track path data is generated and stored which represents a junction with the previously established track, and the track is established to include that junction.

The track may be established in the form of a series of elementary segments spaced apart along the path, and the elementary segments may have a generally rectangular shape. The shape of an elementary segment may be adjustable so as to create bend in the track. A bend may be defined in terms of an angle between an elementary segment and the immediately preceding elementary segment in the track. The angle between successive elementary segments may be selectable and a selected angle may be maintained between successive elementary segments until a different angle is selected.

Preferably, the shape of each segment may be changed so as to twist the track about the direction of the path.

Track path data may be stored as a plurality of path direction vectors and each stored path direction vector may be stored with an associated position vector, each position vector defining a start location for a corresponding path direction vector. The track path data stored may also include a twist angle representing an angle of twist about the path direction vector.

Preferably, the generated track is displayed on a computer screen. The track may be defined by first and second sets of co-ordinates, and members of each set may be linked so as to define first and second sides for the track. The track may be established in the form of elementary segments and each segment may represented by a pair of co-ordinates, such that a first member of the pair is a member of the first set of co-ordinates and a second member of the pair being a member of the second set of co-ordinates.

Preferably, a plurality of members of at least one set of co-ordinates are input to an interpolation algorithm, operative to smooth the representation of the track edge to which the said at least one set relates. The interpolation algorithm may use non-linear interpolation, and preferably uses cubic interpolation. The interpolation algorithm may be iterative. Four adjacent co-ordinates from the at least one set may be input to the interpolation algorithm, and most preferably, the interpolation algorithm generates a point B′ approximately according to the equation:

B′=wₐA+w_{b}B+w_{c}C+w_{d}D

where: A, B, C and D are four adjacent co-ordinates from the first or second set of co-ordinates; B′ is a point in the interval BC, and wₐ w_{b} w_{c} w_{d} are weights applied to points A B C and D respectively, calculated such that

$$\begin{matrix}{w}_{a} = \frac{1 - 3 t + 3 {t}^{2} - {t}^{3}}{6} ; ; & {w}_{b} = \frac{4 - 6 {t}^{2} + 3 {t}^{3}}{6} ; \\ {w}_{c} = \frac{1 + 3 t + 3 {t}^{2} - 3 {t}^{3}}{6} ; & {w}_{d} = \frac{{t}^{3}}{6} ;\end{matrix}$$

where t is in the range 0 to 1.

The display may be presented as viewed from a predetermined camera position within the virtual space and the camera position may be displaceable relative to the virtual space. The camera field of view may be adjustable. As the path is steered through the space the camera may positioned to present a representation of the developing path.

The generated track is preferably displayed in the form of a plurality of polygons. Portions of the generated track within a predetermined distance of the camera may be displayed using a larger number of polygons than portions of the generated track further away from the camera.

The virtual space may be a model of planet Earth an the model of planet Earth may comprises height values equating to heights at different points on planet Earth. The model of planet Earth may model the Earth as a number of cells. Preferably, the Earth is represented by six patches, each patch is split up into a grid of 64 tiles by 64 tiles, each tile is divided up into 128 cells by 128 cells, and a height value is stored for each cell. The stored height value may represent a height at a vertex of the cell.

An interpolation algorithm may be used to determine the height at a point on the model of planet Earth for which no value is stored. The interpolation algorithm is preferably non-linear. Most preferably, a height value for a point P is determined by interpolating between two points A and B using an equation:

f(d)=3d²−2d³

where: d is a fraction defined as distance as

$$\frac{distance ( AP )}{distande ( AB )} ;$$

f(d) is the interpolant for point A; and 1−f(d) is the interpolant for point B.

Alternatively, the virtual space may be a model of a domestic environment, or the virtual space may be initially featureless. Objects may be added to the virtual space, and objects may be automatically added to the virtual space so as to fit about the generated track.

Calculations may be performed to ensure that the path remains on a predetermined side of a boundary within the virtual space. Preferably, a first vector is defined from the centre of a spherical co-ordinate system to a point on the path, a second vector is defined from the centre of the spherical co-ordinate system to a point on the boundary within the virtual world such that said first and second vectors each have the same direction, and the magnitudes of the first and second vectors are compared to determine whether the path remains on a predetermined side of the boundary within the virtual world.

The track path data and the virtual world may be displayed on a computer display using a plurality of polygons, and the display may be subject to a perspective projection view transformation, defined by an aspect ratio, a field of view angle, a camera position and near and far clip planes. The number of polygons to be displayed may be controlled so as to ensure that the necessary calculations can be completed between two temporally adjacent display frames. The far clip plane may be moved so as to control the distance that the camera may see, and therefore control the number of polygons to be displayed. The number of polygons used to display a given display area may also varied.

Preferably, a timer is operated to calculate the time between two successive updates of a given pixel, if the calculated time is greater than the time for each frame, the number of polygons is reduced. If the calculated time is less than the time for each frame, the number of polygons may be increased.

The method described above may be implemented by a computer apparatus which may be a personal computer or games console. The computer apparatus may provide means for storing track path data on a non volatile storage device. The storage may be effected across a computer network, which may be the Internet.

The present invention further provides a computer program for carrying out a track generation method as described above. There is also provided a carrier medium carrying computer readable code means for causing a computer to execute procedure according to the method described above. The carrier medium may be a DVD or CD ROM or communications line.

Racing games are usually provided with a number of predefined tracks. Some games, including games embodying the first aspect of the present invention allow users to generate tracks of their own design.

It is often desirable to allow users to edit a track, either one which they have themselves generated, or one which has been supplied as standard. Although systems exist for generating tracks from elementary building blocks as described above, such systems provide no facilities to allow a user to manipulate the track. No known system allows such track manipulation.

It is an object of a third aspect of the present invention and a fourth aspect of the present invention to provide a track manipulation method.

According to a third aspect of the present invention, there is provided a method of manipulating a track to be followed, comprising selecting at least two points on the track, and applying a predetermined effect to the track between the two selected points.

According to a fourth aspect of the present invention, there is provided an apparatus for manipulating a track to be followed, comprising means for selecting at least two points on the track and means for applying a predetermined effect to the track between the two selected points.

The predetermined effect may twist the track about the direction of the track, an angle of twist may be specified for the area of track between the two selected points, and appropriate twist angles may be computed for parts of the track between the points.

Alternatively or additionally the predetermined effect may be a variable track deformation, and said variable deformation may be applied to the track at the time at which it is followed. The variable track deformation may represented by means of a wave equation which is to be applied to the track between the two selected points. The track may have two sides, may be defined by a set of co-ordinates at each side, and the wave equation may be applied to each point along its length.

The wave equation is preferably of a general form:

displacement=cos M(phase+(speed×time))×size

where cos M is a function such that:

$$cos M ( n ) = cos ( \frac{π n}{M} ) ;$$

speed is the speed of the wave obtained from a lookup table; time is a global clock implemented by the software; size is the amplitude of the modelled wave;

phase=((TrackIndex×PhaseInterval)+PhaseOffset)mod A;

TrackIndex, PhaseInterval and PhaseOffset are all obtained from a lookup table as described below;

& is a bitwise logical AND operation; and

A is an integer.

Data representing a plurality of real time deformations may be stored and the user may select one of said plurality of real time deformations.

Alternatively or additionally, the predetermined effect may comprise applying a texture to the surface of the track, and the effect may applied using a texture mapping algorithm. The applied texture may cause the track to become transparent such that the virtual space is visible through the track. Alternatively or additionally, the applied texture may affect characteristics of an object following track and the characteristics may be changed so as to model a surface effect on the track. The surface effect may be snow, water or dust.

Alternatively or additionally, the effect may comprise deleting the track to be followed between the two selected points.

The track to be manipulated may be provided with a first barrier at a first side of the track, and a second barrier at a second side of the track. In this case, the effect may comprise applying a texture to a barrier and/or adjusting the height of a barrier.

Alternatively or additionally, the effect may comprise adding an object to the track which may be moved to a position adjacent the track. The effect may comprise adding a feature to the track, such that an object following the track is affected by collision with the feature. Such a feature may cause an object colliding therewith to be given an additional propulsion force.

The manipulation method as outlined above, may be implemented by a computer apparatus, which may conveniently be a personal computer or games console

A track generated using a generation method as described above, may be manipulated using a manipulation method as described above.

According to further aspects of the present invention, there is provided a computer program for carrying out the manipulation method described above, and there is provided a carrier medium carrying computer readable code for causing a computer to execute procedure according to the above described manipulation method. Such a carrier medium may conveniently be a DVD or CD ROM, or in alternative embodiment of the present invention, the carrier medium may be a communications line. The present invention also provides a computer game embodying a manipulation method as described above.

In many racing games, it is necessary for the game to generate one or more opponents against which the user can race. Such opponents must be provided with means of navigation about the track on which the race is to take place.

In one known game, a predefined track is provided with means defining the optimum path about the track. Such a path will, for example, take the shortest path around corners. In the known game, the means comprise a line which is plotted along the length of the track, the line is in fact a spline. Opponents provided by the game then use this guideline to achieve a “fly-by-wire” effect.

This known system has a number of disadvantages. No flexibility is provided, as all opponents will always follow the same path about a given track. Furthermore, it is necessary to define an optimal path for each track to act as the fly-by-wire guideline, such a definition is not possible in a game which allows a user to define tracks using a track generator.

It is an object of a fifth and a sixth aspect of the present invention to obviate or mitigate one or more of the problems outlined in the preceding paragraph.

According to a fifth aspect of the present invention, there is provided a method for generating navigational instructions which if obeyed will allow a vehicle to follow a route about a previously established track wherein track geometry is determined by looking ahead along the track in the direction of travel, and instructions are derived in response to the determined track geometry.

According to a sixth aspect of the present invention, there is provided an apparatus for generating navigational instructions defining a route about a previously established track comprising means for determining forthcoming track geometry by looking ahead at forthcoming track, and means for deriving instructions in response to the determined track geometry.

The previously established track is suitably defined by a plurality of co-ordinates and more preferably is defined by a first set of co-ordinates defining a first side of the track, and a second set of co-ordinates defining a second side of the track. Vectors may calculated between adjacent co-ordinates in each of the first and second sets, and these vectors may be used to determine forthcoming track geometry.

The scalar product may be calculated for adjacent vectors on the first or second side of the track, and the scalar product may used to determine forthcoming track geometry. Preferably, the scalar product is averaged over a length of previously established track so as to more accurately determine the forthcoming track geometry.

The navigational instructions generated by the method may be used to automatically navigate an object along the previously established track. The navigational instructions may be amended in response to a forthcoming track surface property such as snow, water or dust.

The accuracy of the navigational instructions produced is preferably adjustable by a user, and the accuracy may be varied by changing the length of forthcoming track that is taken into account when determining forthcoming track geometry.

The method described above may be implemented by a computer apparatus, and the computer apparatus may be a personal computer or games console

Further aspects of the present invention provide a computer program for carrying out a method of producing navigational instructions as described above, and a carrier medium carrying computer readable code for causing a computer to execute procedure to carry out the above described method. The carrier medium may be a DVD or CD ROM or a communications line.

According to a seventh aspect of the present invention, there is provided a computer game wherein a vehicle is navigated over a previously established track using navigational instructions generated using a method as described above.

According to an eighth aspect of the present invention, there is provided a computer game comprising computer program code to cause a computer to execute procedure to operate a track generation method as described above, and/or a track manipulation method as described above and/or a method of producing navigational instructions as described above. Such a computer game may be carried on a carrier medium, which is suitably a DVD or CD ROM.

Embodiments of the present invention will now be described, by way of example, with reference to the accompanying drawings in which:

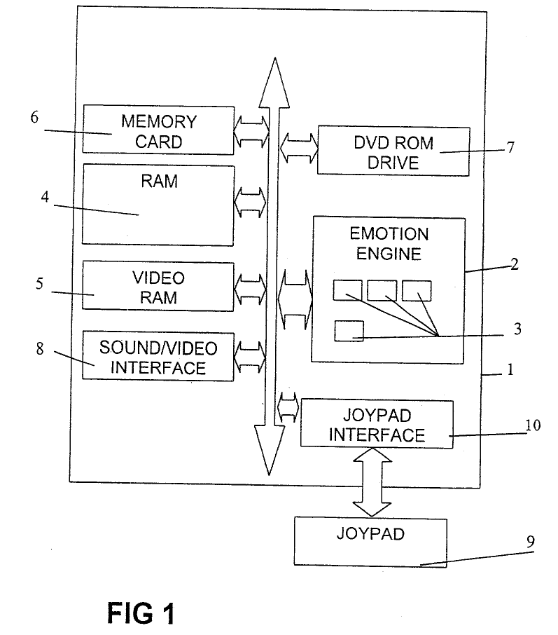

FIG. 1 is a schematic illustration of a games console on which the present invention may be implemented;

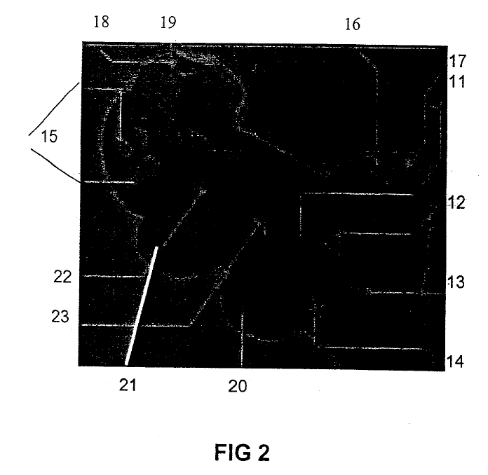

FIG. 2 is a perspective illustration of a controller (hereinafter referred to as a joypad) for use with the games console of FIG. 1;

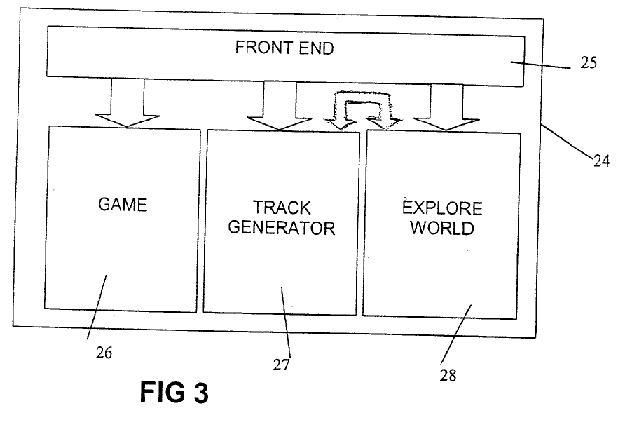

FIG. 3 is a schematic illustration of components of a computer program for implementing the present invention;

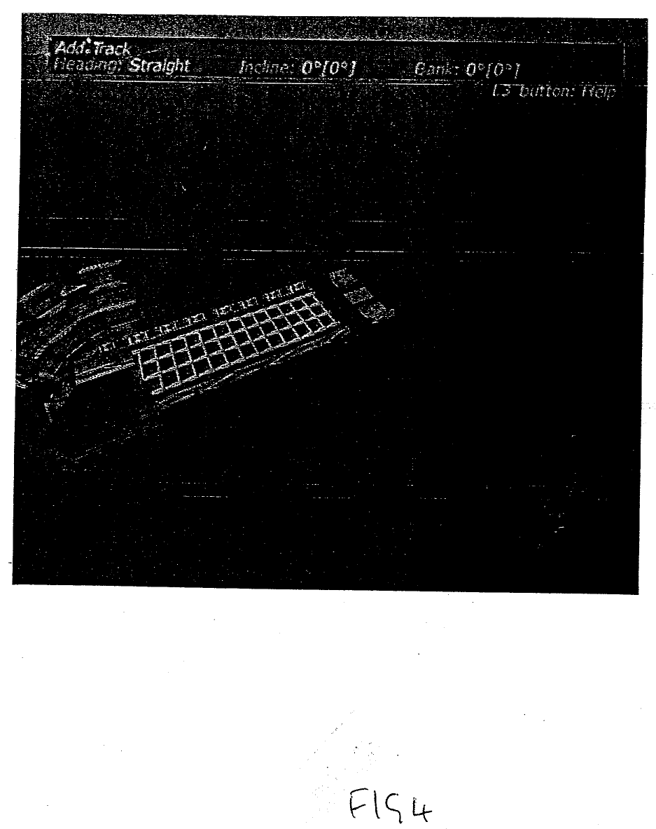

FIG. 4 is a screen dump of an image presented by a track generator component according to the present invention;

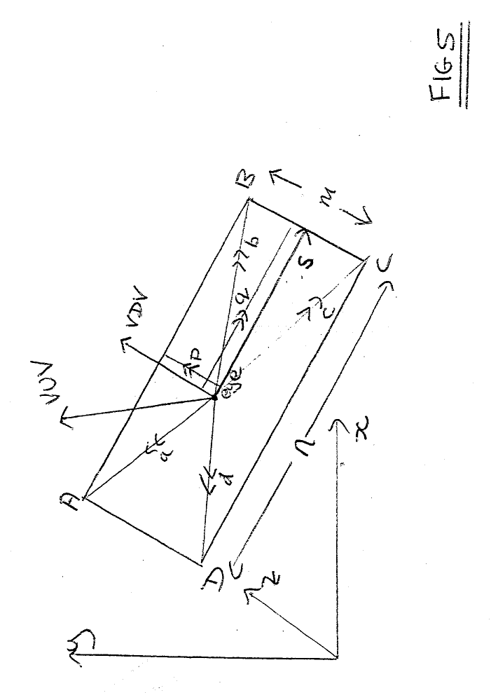

FIG. 5 is a geometric illustration of the process of positioning a first track segment;

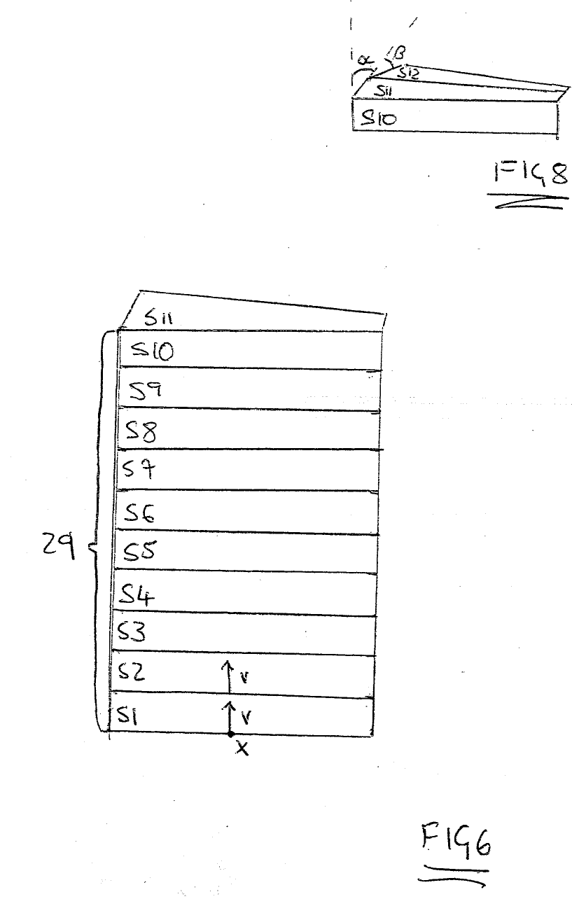

FIG. 6 is a schematic plan view of eleven segments of track assembled using a method of the present invention;

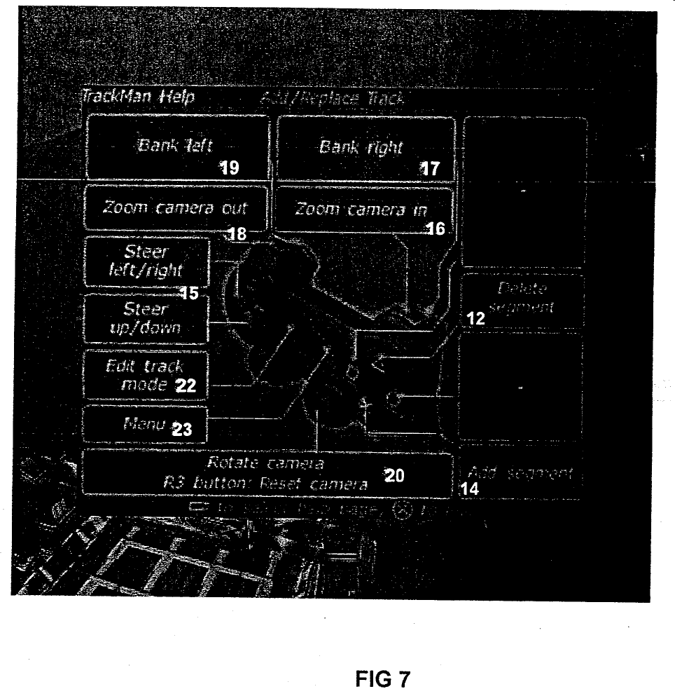

FIG. 7 is a perspective illustration of the joypad of FIG. 2 indicating the functionality of its buttons within an add track mode of the track generator component;

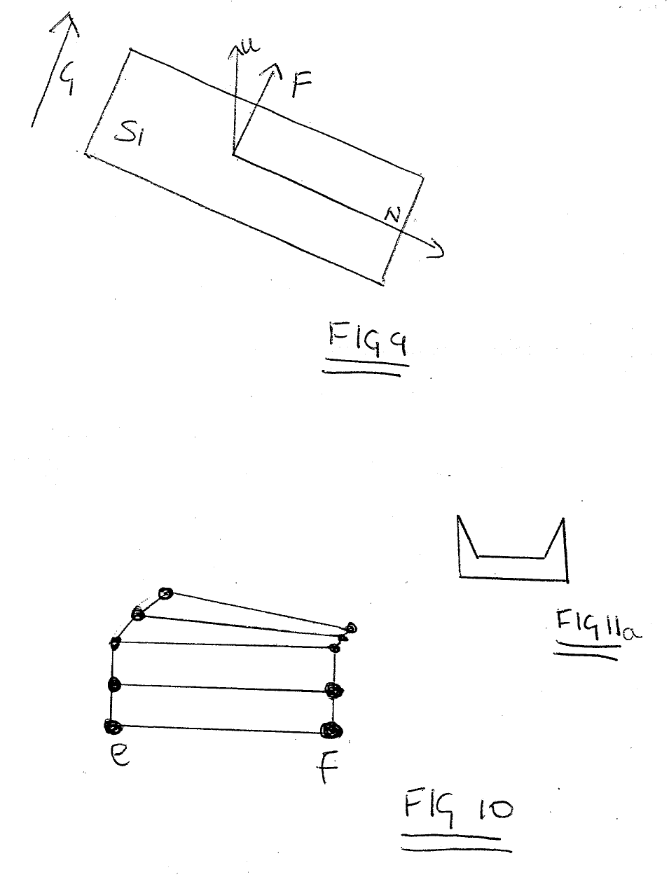

FIG. 8 is a schematic illustration showing how track segments are arranged angularly relative to each other to achieve constant curvature;

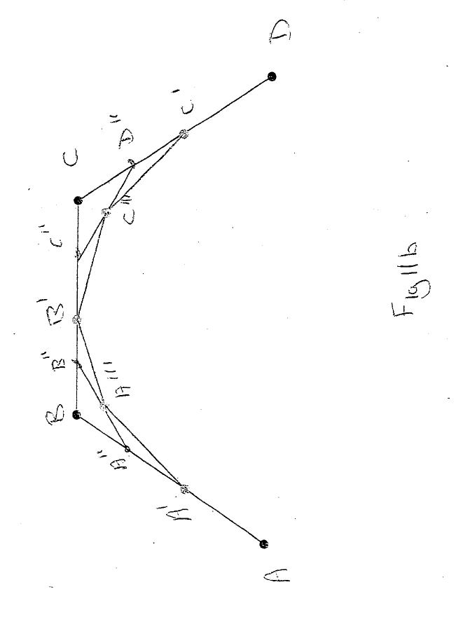

FIG. 9 is a schematic illustration of a single track segment;

FIG. 10 is a schematic illustration of a data representation used in a preferred embodiment of the present invention;

FIG. 11a is a side profile of a track segment used in a preferred embodiment of the present invention;

FIG. 11b is a schematic illustration of a cubic interpolation method used in a preferred embodiment of the present invention;

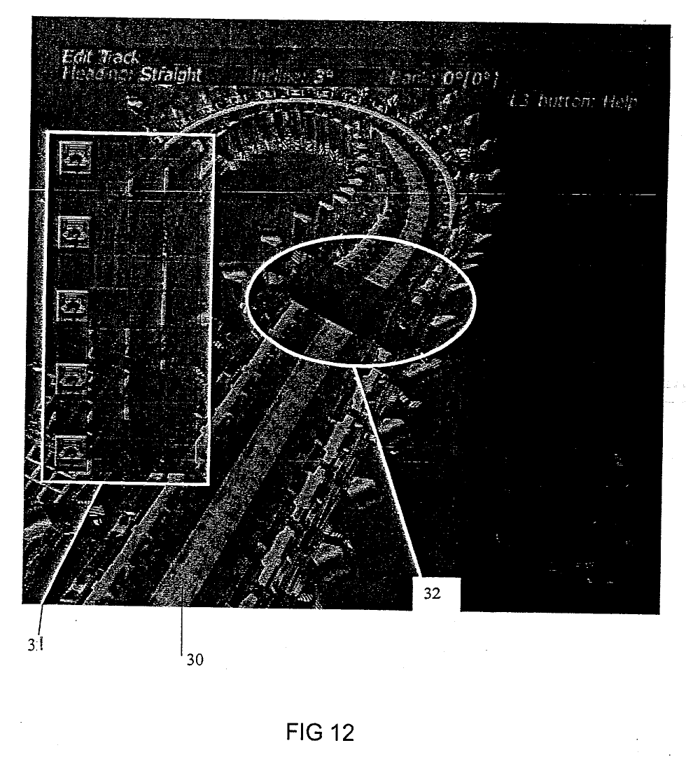

FIG. 12 is a screen dump of an editor module operating in accordance with a preferred embodiment of the present invention;

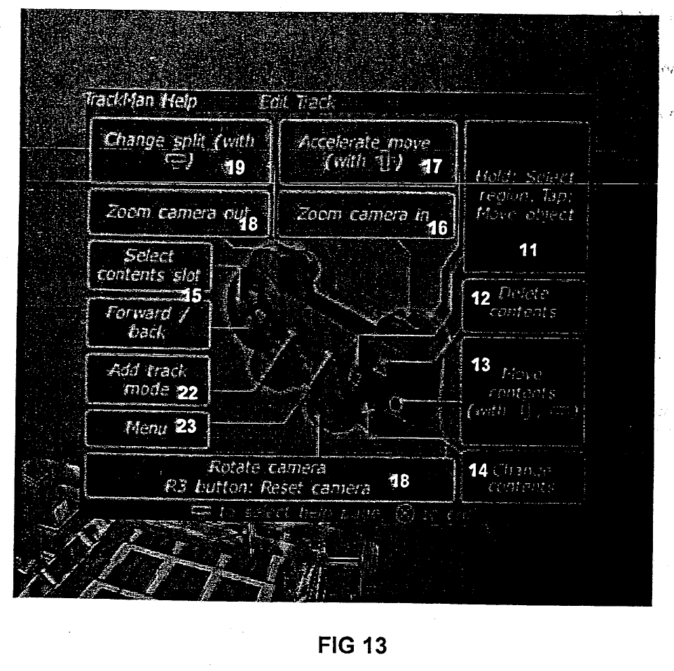

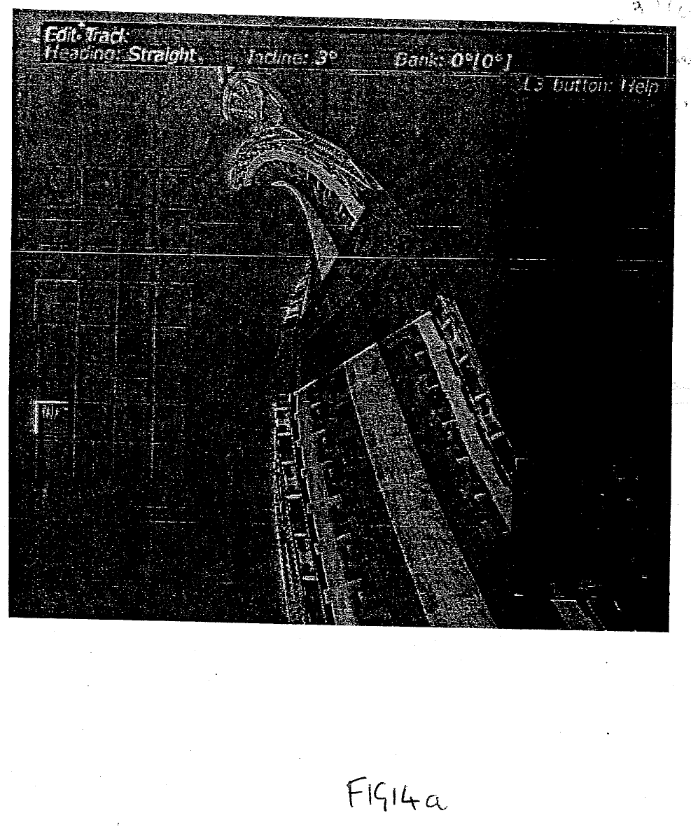

FIG. 13 is a perspective illustration of the joypad of FIG. 2 indicating the functionality of its buttons within an edit track mode of the track generator component;

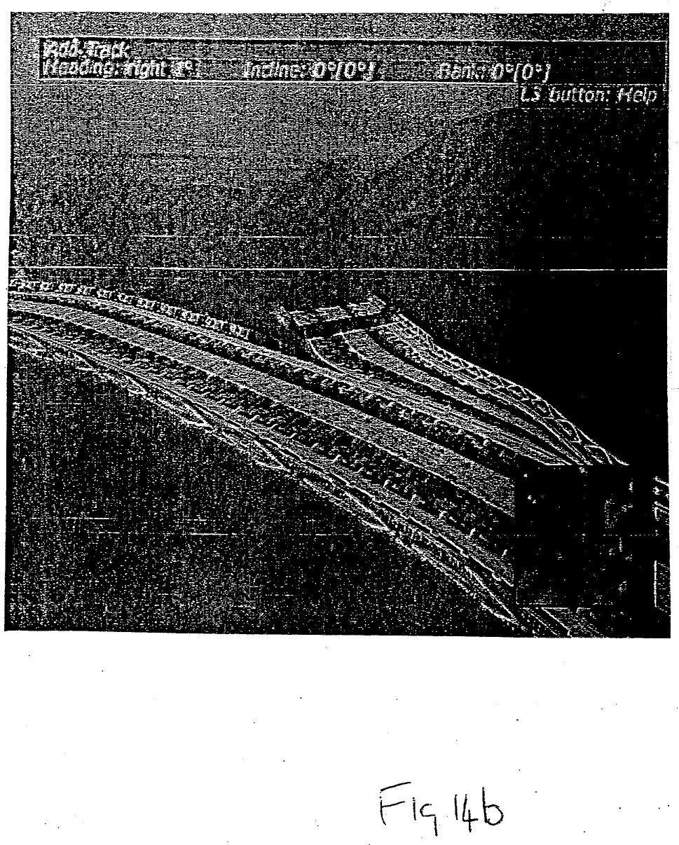

FIG. 14a is a screen dump of a corkscrew effect that may be added to a track created using a preferred embodiment of the present invention;

FIG. 14b is a screen dump of a branch track which may be added to a track using a method according to the present invention;

FIG. 14c is a schematic plan view of a branch track being joined to a main track;

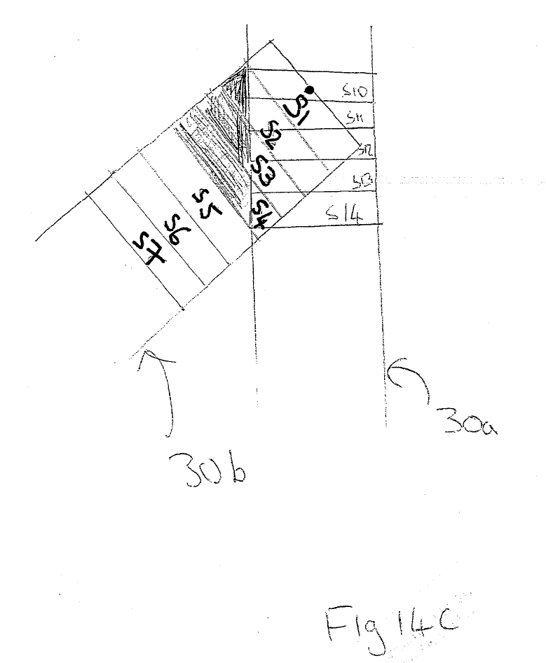

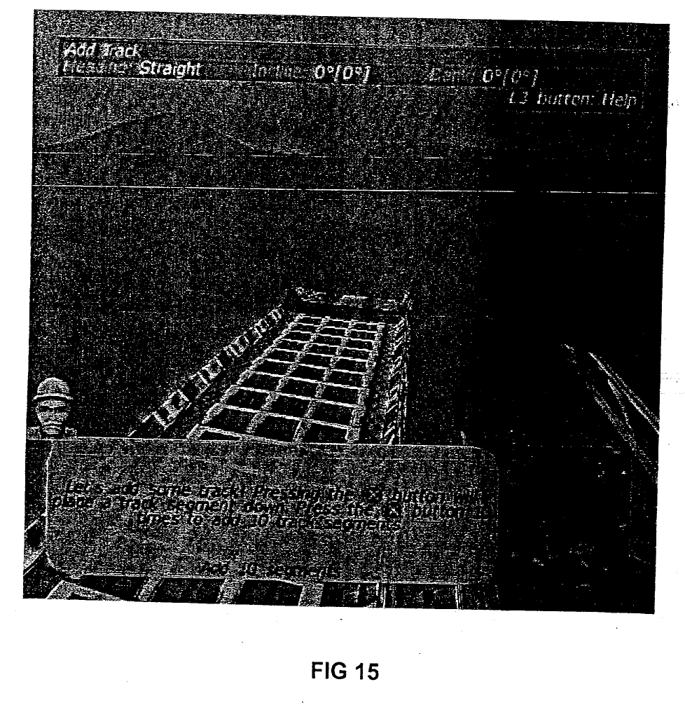

FIG. 15 is a screen dump from a tutorial provided in a preferred embodiment of the present invention;

FIG. 16 is a schematic illustration of an interpolation method used in a preferred embodiment of the present invention;

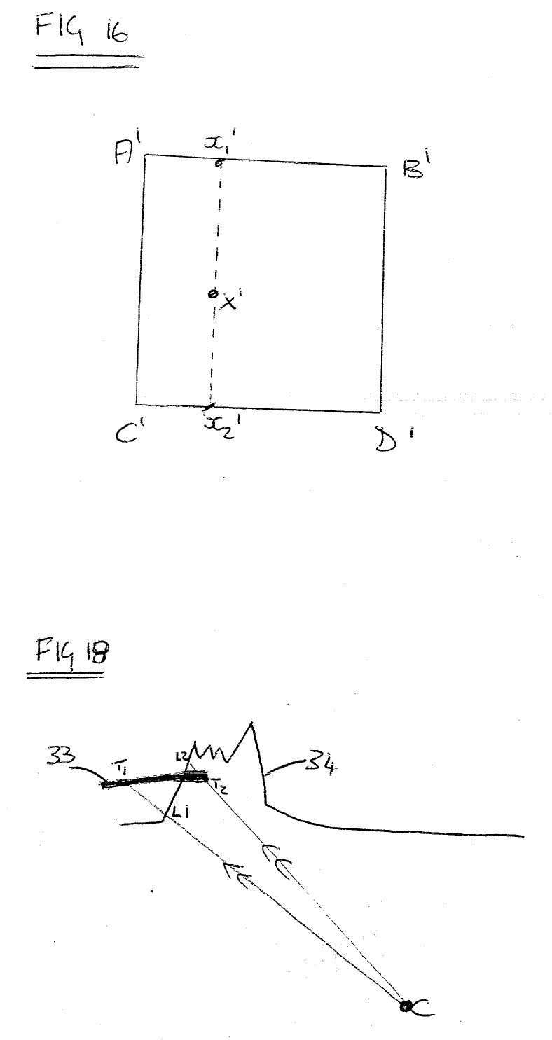

FIG. 17 is a graph of the interpolation function 2x²-3x³ used in a preferred embodiment of the present invention;

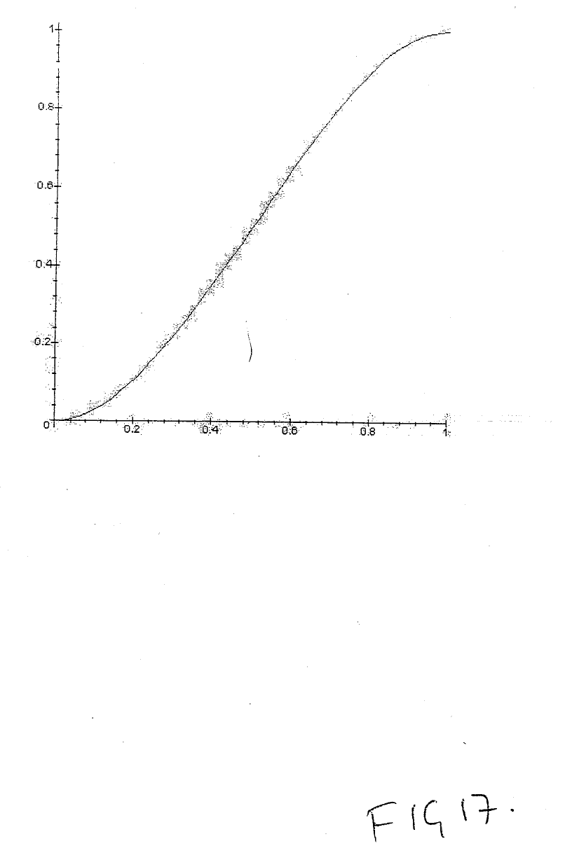

FIG. 18 is a schematic illustration of a ground avoidance algorithm that may be implemented in an embodiment of the present invention;

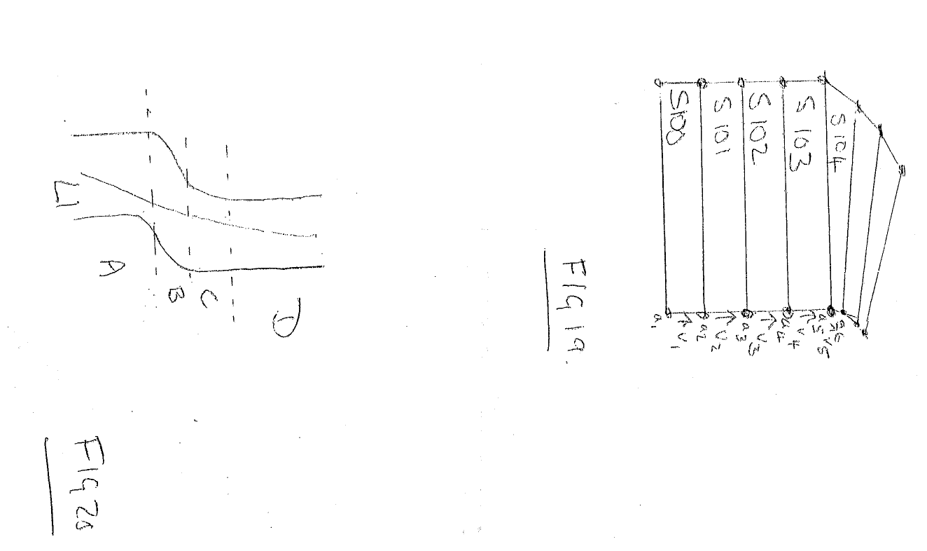

FIG. 19 is a schematic illustration of methods used by an opponent artificial intelligence system provided in a preferred embodiment of the present invention; and

FIG. 20 is a schematic illustration of a track configuration.

Referring first to FIG. 1, there is illustrated a known games console on which the present invention may be implemented. The games console illustrated in FIG. 1 is that known as the PlayStation.2, marketed by Sony® Computer Entertainment Incorporated. The games console 1 comprises a plurality of processors collectively referred to as an emotion engine 2. The emotion engine 2 comprises a number of individual processors 3 including a 128 bit central processing unit (CPU) with associated floating point co-processor and vector graphics co-processor and a stand alone vector graphics processor to enhance the performance of vector graphics operations.

There is also provided Random Access Memory (RAM) 4 of known form. The RAM 4 stores both program instructions to be executed by the processors of the emotion engine 2 and data to be used by these instructions. The console further includes dedicated Video RAM (VRAM) 5 to improve graphics performance, and can accept one or more memory cards 6, each having a storage capacity of 8 MB, which are connected to the games console. The memory cards 6 provide a writable storage medium such that game data created by a user may be preserved on a memory card 6. Furthermore, memory cards may be moved between consoles, thereby allowing members of the games community to share data with one another.

Game data and code is read from a digital versatile disc read only memory (DVD ROM) drive 7 which can access both DVD and compact disc (CD) data carriers. The use of DVD is advantageous because of far higher data storage capacity as compared with CD. Video and sound is output from the console 1 by means of a sound and video interface 8 to a conventional television. It is also possible to direct sound output from the sound and video interface 8 to other audio visual equipment so as to benefit from the improved sound quality provided by the Dolby Digital, AC-3 and DTS surround sound formats supported by the PlayStation.2 games console.

A user interacts with the console 1 by means of a controller, known as a joypad 9 which connects to a joypad interface 10. Functionality of the joypad will be described in further detail below, although it should be noted that in addition to providing input data to the games console 1 the joypad 9 also acts as an output device by means of a vibrator such that more realistic game playing can be achieved by a user holding the joypad in his hands. The games console 1 may support more than one joypad 9 so as to allow more than one user to utilise the console concurrently and achieve multi-player gaming.

Referring to FIG. 2, the joypad 9 of FIG. 1 is illustrated in further detail. The joypad comprises a number of buttons for receiving user input. The functionality provided by each of these buttons will vary depending upon the game being played and also upon the current mode within that game. Discussion of the functionality will be presented below, although the constituent buttons of the joypad are identified here.

The joypad includes four buttons, each identified by a shape. A button 11 having a square printed thereon, a button 12 a triangle, a button 13 a circle and a button 14 a cross. There are also provided four arrow buttons 15 representing up, down, left and right directions. The joypad has four shoulder buttons, two provided on each shoulder of the joypad: an upper right shoulder button 16, a lower right shoulder button 17, an upper left shoulder button 18 and a lower left shoulder button 19. There are provided two analog stick controls: a right stick control 20 and a left stick control 21. Adjacent the two analog stick controls 20, 21 there are provided two further buttons 22 and 23.

In use, a user holds the joypad with both hands such that the user's left thumb may operate the arrow buttons 15, the left analog stick control 20 and the button 22 and the user's right thumb may operator the shape buttons 11, 12, 13, and 14 together with the right analog stick control 20 and the button 23. The index finger and middle finger of the right hand can operate the right shoulder buttons 16 and 17 while corresponding fingers of the left hand may operate the left shoulder buttons 18 and 19.

A computer program embodying the present invention is supplied on a DVD ROM disc. The DVD ROM disc contains essentially two types of data. A first section comprises an executable file which is run when the disc is inserted into the DVD ROM drive (7 in FIG. 1) of the games console. The first section further comprises other code containing files which have been linked to the executable file during a standard linking process. Instructions from this section of the DVD ROM are read into the RAM 4 of the console 1 for execution by the processors of the emotion engine 2 in a conventional way.

A second section of the DVD ROM contains data which is accessed by the executable code of the first section. This data will include graphics files in bit map format which are to be placed within the image output by the games console by means of the sound/video interface. This data will also include data that is used to render the various images within the game. The significance and use of this data will be discussed in further detail below.

Referring now to FIG. 3, a schematic illustration of the components of a computer program embodying the present invention is shown. The program 24 comprises a front end component 25, a game component 26, a track generator component 27 and an explore world component 28. The functionality of each of these components will be described in further details below.

The front end provides an interface which a user operates to navigate about the other components of the program, and also to configure the game component 26 for use. The game provided is such that a user may race a craft on a number of tracks. The game is provided with thirty standard tracks, with functionality being provided (by means of the track generator 27) to create additional tracks.

The race provided by the game component 26 is first configured by a user specifying values for a number of parameters in the front end component 25. These parameters include a specification of whether one or two players are playing the game, the number of opponents that are to be provided by the game, and characteristics of these opponents. Characteristics of opponents include their expertise which is provided by Artificial intelligence (AI) techniques and is referred to hereinafter as an AI Level. It is also possible to choose the craft which is to be raced from a predefined set of craft.

The game provides two different methods of competition. The first is a time trial competition wherein a user competes against the clock to obtain a time. The second method of competition (known as series mode) is a traditional race wherein a number of opponents compete against one another to race on a track. These opponents will include a further player in a two player game and in any event opponents generated by the game software.

Having configured the game using the aforementioned parameters, a user then chooses the track on which the competition is to take place. The thirty supplied tracks are split into five series of six tracks each. Three of these series contain slalom tracks, that is tracks having a start and an end distant from one another and the remaining two of these series contain circuit tracks. The tracks in each series are graded for difficulty such that the first track is the most straightforward whilst the sixth track is the most complex.

Initially a user can access and race the first track from one slalom series and the first track from one circuit series. When operating in series mode, completion of the first track in each series (regardless of the competence achieved in this completion), allows the user to progress to the next track and so on. A user completing all tracks in the first circuit series, and doing so with a predetermined number of points, will then have access to the first track of the second circuit series and so on. The second and third slalom series are unlocked in similar ways.

When competing in series mode, tracks within a series must always be completed in the predetermined order. That is, even if track two of the first series has been unlocked previously, it is always necessary to start from track one and complete this track before proceeding to the second track and so on. In contrast, once unlocked, it is possible to compete in time trial mode on any unlocked track. That is, for example, if the sixth track of the second series has been unlocked a user may initiate a time trial competition on this track directly. However, it is only possible to unlock further tracks within a series and indeed further series, in series mode, not in time trial mode.

Furthermore, although a series must always begin with track one of that series, it is possible to start on a series other than the first if suitable unlocking has taken place. For example, if the second slalom series and one or more of its constituent tracks have been unlocked previously it is possible to begin racing in series mode on track one of slalom series two, or to begin racing in time trial mode on any unlocked track of series two.

Having selected a track to race in series or time trial mode a race then takes place along conventional lines. Various features of such a race will be presented in more detail below.

Referring back to FIG. 3, it can be seen that the front end component 25 gives access to an Explore component 28. The purpose of the Explore component is to allow a user wishing to create a new track using the track generator 27 to explore a predefined space so as to determine where he would like to position the start of his track in a virtual space or “world” defined by the software. Embodiments of this Explore component will be described in further detail below. Having selected a point in the world where it is desired to begin track creation, a user can press an appropriate key on the joypad to activate the track generator component.

Operation of the track generator component will now be described in some detail. On activating the track generator component the user is presented with output as shown in FIG. 4. The game software takes the co-ordinates of the cursor position within explore mode when the appropriate key was pressed and generates ten straight track segments of known length starting from this point. The user views the arrangement from an eye point situated at the start of, and slightly above the track. This eye point is then used to generate a view frustum and perform distance and other calculations in a conventional way. The ten segment track as automatically generated is rendered in real-time from data structures described below.

The first track segment is positioned such that the point at which track generation was initiated is centrally located within it, and the track is extended in the direction of the view direction vector, that being the direction in which the eye is looking.

Referring to FIG. 5, the process of determining corner co-ordinates A, B, C D of the first track segment is described. An eye point denoted eye has co-ordinates (xₑ, yₑ, zₑ) and is shown in a conventional three dimensional co-ordinate system. A view direction vector VDV determines the direction in which the eye is looking and a view up vector VUV (which in this case is the same as the track up vector) determines an up direction relative the eye. The sides DA and CB of the rectangle are located parallel to the view direction vector whilst the sides AB and DC of the rectangle are located perpendicular to the vector VDV. In order to determine co-ordinates of A, B, C and D the following operations are carried out.

First a vector S is calculated thus:

$$S = \frac{VDV}{\vert VDV \vert} \times \frac{VUV}{\vert VUV \vert} \qquad ( 1 )$$

Where:

S is a side vector as shown in FIG. 5, being parallel to sides AB and DC of the desired rectangle;

|VDV| is the magnitude of VDV;

$$\frac{VDV}{\vert VDV \vert}$$

is a unit vector in the direction of VDV;

|VUV| is the magnitude of VUV; and

$$\frac{VUV}{\vert VUV \vert}$$

is a unit vector in the direction of VUV.

Similarly, calculating

$$\frac{S}{\vert S \vert}$$

yields a unit vector in the direction of S.

The central point of the segment (eye) is known, as are the dimensions of the desired segment which is predetermined. Unit vectors representing the directions of the sides of the segment,

$$\frac{S}{\vert S \vert} and \frac{VDV}{\vert VDV \vert}$$

have also been calculated.

Vectors p and q as illustrated in FIG. 5 can be computed as follows:

$$\begin{matrix}p = ( \frac{VDV}{\vert VDV \vert} \times \frac{m}{2} ) & ( 2 ) \\ q = ( \frac{S}{\vert S \vert} \times \frac{n}{2} ) & ( 3 )\end{matrix}$$

where the segment is of dimension m in the direction of VDV and n in the direction of N as shown in FIG. 5.

It is then possible to use the computed vectors p and q to generate four vectors a, b, c and d. which can be added to the known eye point to give the co-ordinates of points A, B, C and D respectively.

That is:

a=p−q

b=p+q

c=q−p

d=−(q+p) (4)

A=eye+a

B=eye+b

C=eye+c

D=eye+d

Having determined the position of the first track segment as described above, the edit time track data format comprises a plurality of (position vector, direction vector) pairs. This data format will be described with reference to FIG. 6, where the track 29 comprises ten initial segments denoted S1 to S10. The edit representation of this track will comprise an initial start point X representing the centre point of a line representing the start of a track segment together with a vector V representing the direction in which the track proceeds. The start point X is defined as a vector, relative to the centre of a spherical co-ordinate system. Such a vector will, by definition, always represent the global up direction in this spherical co-ordinate system. The representation further comprises a twist angle for each section of track, being the angle of twist (described in further detail below) that is applied to that segment of track.

The user is able to edit the final section of positioned track by causing it to turn in a left or right direction, causing it to slope up or down or causing it to twist (or bank) in a left or right direction. It was mentioned above that a single twist angle is stored for each track segment. This is associated with the leading edge of the segment, that is the side at which the position vector is defined. Cubic interpolation (described in further detail below) is then used to determine the shape of each segment, having regard for the twist angle of each track segment.

Referring now to FIG. 7 the buttons of the joypad describe above are illustrated. The right and left and up and down arrow buttons 15 represent moving the track to the left or right or up and down respectively. FIG. 6 shows how segment S11 of track is curved to the left. Having decided on the orientation of the final segment of laid track (S11 in this case) a user may use button 22 to add a further segment of track. If the previous segment of track is proceeding in a straight forward direction, the next piece is laid in a similarly straight forward direction (e.g. the relationship between segments S3 and S4 for FIG. 6). However if a track segment is added to the end of segment S11 which is angled to the right, the angle of the new track segment is calculated to be constant relative the previous section. This is illustrated in FIG. 8.

Referring to FIG. 8, there is illustrated track segments S10 and S11 as shown in FIG. 6 together with a further track segment S12. The angle between S10 (which is proceeding in a straight forward direction, and S11 is denoted α. The angle between S11 and S12 is denoted β, where α=β. Thus, each new segment of track is laid so as to create a continuously curving track. Therefore, segment S12 will be positioned at an angle of α+β relative to S10.

This preservation of angle of curvature, measured relative to the preceding track segment, allows smoothly curved tracks to be created. This is what a user is most likely to want to do when creating a track. Referring back to FIG. 7, the user hits the cross button 14 to add a track segment and uses right and left arrow buttons to configure this segment's curvature. Addition of further segments by use of the cross button 14 will generate a constant curve, without further user interaction with arrow buttons 15, thereby providing an intuitive interface for the creation of curved track lengths.

In contrast, if a track segment is positioned so as to create an incline, the angle remains absolute, that is the angle of incline is measured relative a fixed point, not relative to the previous segment of track. Similarly, if a track is banked (which is achieved using the bottom left and right shoulder buttons denoted 17 and 19 in FIG. 7), the angle of twist is measured absolutely, not relatively.

The provision of incline using angles measured absolutely, allows the creation of inclines of constant gradient, as a user is most likely to desire. That is, referring once more to FIG. 7, the user hits the cross button 14 to add a track segment and uses up and down arrow buttons 15 to configure this segment's incline. Addition of further segments by use of the cross button 14 will generate a constant incline. When the user feels that the track has been raised to the desired level, by the addition of further segments of track at the defined angle, the up and down arrow buttons 15 can once more be used to decrease the incline, and thus to “flatten” the track once more. In some applications, a user may want to insert a corkscrew or “loop the loop” effect into the track, that is to create an area of track that is upside down. The present embodiment allows the creation of a smooth loop formation by combined use of the cross button 14 to add track while holding down the up arrow button 15 to constantly increase the angle of inclination.

Similarly, if it is desired to twist an area of track, the angle of twist is set once, and further segments added through use of the cross button 14 will be placed at this twist angle. Again, if it should be desired to create a corkscrew by twist, this can be done by concurrent use of the cross button 14 to add track segments together with top left and right shoulder buttons 16, 18 to alter the twist angle.

The vector geometry associated with a track segment will now be described. It has been mentioned previously that the edit time geometrical representation comprises position and forward vectors together with a twist angle. These three components allow computation of a track sideways vector. Referring to FIG. 9, this represents a single segment of track S1 with three axes. A first axis denoted F represents the forward vector, that is the direction of track progression, a second vector U represents the up direction, relative to the track, and a third axis N is perpendicular to each of these, and is known as the sideways vector. The edit-time representation of position is achieved by means of a position vector relative to the centre of a spherical co-ordinate space. This vector is denoted G in FIG. 9, and is the global up vector.

As G, F and the twist angle (not shown in FIG. 9) are known from the edit time data representation, the vector N may be calculated by performing:

N′=F×G (5)

and subjecting the resulting vector N′ to a rotation through the twist angle about the vector F to give N.

When N and F are known, U can be computed by:

U=F×N (6)

The curvature, inclination and twist operations are all achieved by means of rotations of a track segment about an appropriate axis. Given these three axes (F, N, U), curving an area of track by θ° is a rotation by θ° of the axis F about the axis U. Twisting an area of track by φ° is a rotation by φ° of the axis U about the axis F and inclining an area of track by φ° is a rotation by φ° of the axis F about the axis N.

Rotating one vector about another vector is a well known mathematical process, and is defined by:

v′=u*(1−cos θ)*(v·u)+(v×cos θ)+(u×v)*sin θ (7)

where:

v is a vector to be rotated;

u is a unit vector about which v is to be rotated;

θ is the angle through which v is to be rotated about u;

× is the vector cross product operation;

* is standard mathematical multiplication; and

· is the scalar (or dot) product operation, which is defined, for two vectors (aₓ, a_{y}, a_{z}) and (bₓ, b_{y}, b_{z}), to give a scalar v such that v=aₓbₓ+a_{y}b_{y}+aₓb_{z}.

The ability to effectively “drive” a track onwards through a predefined space and define bends, inclines and twists in this manner allows the creation of an almost limitless number of track layouts with no restriction whatsoever. This powerful functionality is intuitively provided to a user, through use of the cross button 14 to add track segments while using the arrow buttons to determine curvature, incline and banking as described above. Furthermore, additional functionality described below adds even more flexibility in terms of the ways in which a generated track may be manipulated.

When in the mode described above, in which track can be added and manipulated, the last added segment which is not yet fixed is highlighted in a different colour to the remainder of the track. Track segments can be deleted using the triangle button 12.

It has been described above how a track can be represented as a plurality of (position vector, forward vector) pairs. This is the representation used while a track is being created and edited by a user. However, such a representation is not convenient for generating a track that is to be displayed. Thus, a different representation is used, as shown in FIG. 10. Here each illustrated segment is represented by four points, representing corners of that segment. Thus, a complete track representation for n segments will involve (n+1) co-ordinate pairs. That is a pair is generated for each additional segment, and the start line will represent an additional pair denoted (e, f).

This co-ordinate pair representation is used to generate a track image as illustrated in FIG. 4. The co-ordinates are used to generate a plurality of triangles which can then be rendered in a conventional manner to generate the displayed graphics.

The generation of the co-ordinate pair representation used to display the track is carried out as the track is generated. That is, a track segment is added, or its properties altered in the edit mode representation (position vector, direction vector and twist angle) and this is instantly reflected in the co-ordinate pair representation.

The translation between the two representations can be performed by taking the edit time representation, and calculating a unit vector in the direction of N as described above. N is then multiplied by half the desired track width and added to the position vector to give one of the co-ordinate positions. The same value is subtracted from the position vector to yield the second co-ordinate position.

The co-ordinate pair representation is an efficient way of rendering the track both during creation within the track generator component and during a race within the game component. Thus, a truly what you see is what you get (WYSIWYG) environment is produced. This use of a common representation for both creation track and racing improves the usability of the game as a user need only learn one interface. Furthermore, any created track can be instantly used with no conversion between representations being necessary to obtain a track in a form which may be raced.

In the preceding discussion, and in particular in FIGS. 6, 8 and 9 the track has been described in terms of two dimensional rectangular segments, presented in plan view. In reality the track is a three dimensional object having a thickness, and also having barriers protruding from it at its right and left sides. A typical track profile is shown in FIG. 11a. The above discussion is described in two dimensional terms only for reasons of simplicity, and to illustrate the basic concept of generating a track from a plurality of segments. It should also be appreciated that although FIGS. 6, 8 and 9 show sharp bends between adjacent segments, in fact the co-ordinate pairs are used to generate smooth curves to improve the graphics displayed to a user, using an interpolation method described below.

The representation of the track as a plurality of co-ordinate pairs is supplemented by further information including a left barrier height value, a right barrier height value, a left barrier texture value, a right barrier texture value and a track texture value. It is possible to vary each of these parameters, and a process of achieving this will be described below.

The application of a texture to an area of a track, that is the application of a pre stored bitmap image to the polygons representing the track uses a well known technique commonly referred to as texture mapping. Texture mapping gives the impression to a user that the polygons to which the texture is applied are in fact made of the material represented by the bitmap. The technique involves taking a bitmap image represented in pattern space and applying it to the surface of the object by performing a mapping operation. Details of texture mapping algorithms can be found in commonly available computer graphics textbooks including: Watt, Alan “3D Computer Graphics, Second Edition”, Addison Wesley 1993.

Right and left barrier height values are used to construct barrier heights perpendicular to the track surface. Such barriers take a predefined profile as shown in FIG. 11a, and the combination of a known profile with height information allows easy transformation of this profile to the desired height. Barriers are smoothed using a cubic interpolation technique as outlined below. Barriers can be texture mapped in the same way segments of track, as has been described above.

It should be noted that the texture information and barrier height information are not stored individually for each segment. Instead, they are stored in terms of ON and OFF signals. For example, track textures for forty segments of track (S1 to S40) may be stored thus:

S1 Texture 1

S3 Texture 3

S20 Texture 1

S30 Texture 2

S38 Texture 3

That is segments S1 and S2 are textured using a bitmap associated with texture 1, segments S3 through S19 are textured using a bitmap associated with texture 3, S20 through 29 with the bitmap of texture 1, segments 30 through 37 with texture 2 and segments 38 to 40 with texture 3. The bitmaps (for both the barriers and the main track) are blended together by using alpha values to fade one over the other.

Barrier height and texture information is stored in a similar format to that shown above for track texture information. User manipulation of texture and barrier height parameters will be described below.

Having created a track comprising a number of track segments arranged in a desired configuration, a user is able to save this track in order to allow its immediate use for a race and also to allow its use in the future. Track data is stored on memory cards (6 in FIG. 1) which are connected to the games console. The track geometry is stored on the memory card in terms of the edit time representation, that is a (position vector, forward vector) pair and a twist angle for each segment of the track. This information provides sufficient information to represent the geometry of any created track.

Texture, barrier height and other user definable information described below is stored on the memory card for each track segment. More detailed description of this representation will be presented below, along with details of the various manipulations that may be carried out. The storage of track data on a memory card which is removable from the console provides a convenient way for the sharing of tracks between a plurality of users. Tracks stored on a memory card in this way can be opened for editing using the aforementioned functionality such that track segments may be added or deleted as described above.

In some embodiments of the present invention, it may be possible to save a generated track and upload this information to an Internet Website so as to allow tracks to be shared amongst members of the gaming community.

Referring back to FIG. 7, which illustrates the joypad showing the functionality of its various buttons, it can be seen that the top right shoulder button 16, the top left shoulder button 18 and the right analog stick control 20 allow movement of the camera position. The significance of these controls is now described.

By default, the eye (or camera) position starts at the beginning of the generated track, a small distance above the track. As further track is added using the button 14, the camera moves along the track. This is achieved by defining a vector from the current segment to the camera position. This vector is updated on addition of a new track segment so as to move the camera along with the track.

It may be desirable however, to view the generated track from a different point. For example a side view. It is thus possible to use the right analog stick control 20 to move the camera position. Furthermore, it is possible to zoom the current view so as to see a larger area in less detail or a smaller area in more detail as appropriate.

If the view is altered in this way, and subsequently a new track segment is added, the camera position will move to the position dictated by the predetermined vector defined between a track segment and default camera position. It is possible, in some unconventional track set ups, that other track will intersect the vector between the camera and newly added track segment so as to obscure the track.

It was mentioned above that bends in the generated track are smoothed so as to present smooth curves. Similar techniques are used so as to present smooth twists and smooth inclines. The smoothing is implemented using a form of cubic interpolation to split an area between two co-ordinates into a number of sub-areas, and applying polygons to each of these sub-areas individually thereby giving the impression of a curve.

The cubic interpolation method used in a preferred embodiment of the present invention will now be described with reference to FIG. 11b. Referring to FIG. 11b, there is illustrated one side of three track segments AB, BC and CD. Other sides of the track segments are not shown in FIG. 11b for reasons of clarity, although it will be appreciated that a process similar to that described below is applied to these other sides.

The three track segment sides are defined by four co-ordinates, marked A, B, C and D. It is desired to take these points and form a smooth curve.

The line AB is divided at its midpoint by a point A′, the lines BC and CD are similarly divided at their midpoints by points B′ and C′. The line A′B is then divided at its midpoint by a point A″, the line BB′ by B″, the line B′C by a point C″, and the line CC′ by a point D″

Points A″B″ are joined by a line, as are points C″D″. Midpoints of each of these two lines are then calculated and are marked A′″ and C′″ respectively. After one iteration of the cubic interpolation algorithm, the track side BC is represented by points A′″, B′ and C′″. Subsequent iterations will further divide the line segments so as to provide a yet smoother curve. A preferred embodiment of the present invention splits one segment using 17 points, thereby providing 16 regions therebetween. Four iterations of the algorithm as described with reference to FIG. 11b will be require to achieve such a division.

The iterative algorithm described above, can be expressed in mathematical terms. The mathematical description that follows represents an infinite number of iterations of the above algorithm. In practice, the iterative approach described above is used to approximate the following mathematical description.

Given four consecutive control points A, B, C and D as shown in FIG. 11b, the position of point B′ on line BC as shown in FIG. 11b will be defined by the following equation:

B′=wₐA+w_{b}B+w_{c}C+w_{d}D (8)

where:

A, B, C, D are the points as described above; and

wₐ, w_{b}, w_{c}, w_{d} are weights applied to these points.

The weights in equation (8) are given by the following equations:

$$\begin{matrix}{w}_{a} = \frac{1 - 3 t + 3 {t}^{2} - {t}^{3}}{6} & ( 9 ) \\ {w}_{b} = \frac{4 - 6 {t}^{2} + 3 {t}^{3}}{6} & ( 10 ) \\ {w}_{c} = \frac{1 + 3 t + 3 {t}^{2} - 3 {t}^{3}}{6} & ( 11 ) \\ {w}_{d} = \frac{{t}^{3}}{6} & ( 12 )\end{matrix}$$

where:

t is a parameter such that 0≦t≦1, and the particular value of t is a fractional distance between the points BC at which a value is to be calculated. t therefore takes a value equating to the fractional distance usually computed for interpolation calculations.

The curve defined for each track segment side using the method described above, is a cubic spline, and has a number of desirable properties, including the fact that the curve for any two adjacent sides will join in a continuous manner.

Having applied the cubic interpolation algorithm to each side of the track, the points created are linearly interpolated across the width of the track, and the corresponding polygon is fitted with a triangle mesh. This triangulation is carried out in strips across the track segment.

The above description has concentrated on the application of the cubic interpolation algorithm to curved areas of track. All interpolations are done in terms of the left/right vectors. Thus it is not necessary to perform individual interpolations for incline, twist etc. as the same vector interpolation works for such track features.

It was mentioned above that the camera can be moved about a scene and also zoomed. It will be appreciated that more interpolation will be required for an image shown in greater detail. However, applying a high quality cubic interpolation greatly increases the number of polygons needed to represent a track segment such that more memory and processor power is required to display the image. A preferred embodiment of the present invention therefore determines the quality of interpolation to be applied to a segment on the basis of its distance from camera. That is a segment very close to the camera will have a high quality interpolation applied to it so as to achieve the desired smoothness, while a segment distant from the camera will have a lower quality interpolation applied to it, as this will be acceptable at such a distance. The quality of interpolation applied is controlled by the number of iterations of the cubic interpolation algorithm that are used.

It is important to note that the transition from high quality interpolation for segments close to the camera to low quality interpolation for segments distant the camera should be gradual so as not to be detectable by a user.

Having discussed the addition of new track segments, the process of manipulating some of the attributes described above (e.g. barrier height and texture) will be described, along with additional functionality not heretofore mentioned. The track generator component contains an editor module for performing these operations.

In the editor module, a user is presented with a track which has been created together with a grid. A suitable screen is illustrated in FIG. 12, where the output comprises a display view 30 of the track together with a grid view 31. The grid view comprises a grid of four columns and nine rows. Each row represents one segment of the track. A segment 32 which is being edited is highlighted in both display view 30 and the grid view 31.

The main purpose of the editor module is to add features to the generated track environment. Features that may be added can be classified into three categories viz: track based objects, track side objects and collidables. Each of these will be described in further detail below.

Each cell of the grid 31 can contain one object. As each segment has four cells associated with it, four objects may be added to each segment of track. The particular column in which an object is inserted is not of relevance—an object is initially placed centrally in the selected track segment regardless of its column and can be subsequently moved from side to side within the display view.

Referring now to FIG. 13, there is illustrated the joypad together with the functionality of each of its keys in edit mode. To add a feature, a user uses the arrow buttons 15 to select a row and column of the grid to which an object is to be added. When the desired cell is selected, a user may use the cross button 14 to display a menu allowing selection of an object to be added. The choice of objects is controlled through a hierarchy of pull down menus which are displayed at the top of the display. Such hierarchical menu systems are well known from operating systems providing graphical interfaces.

The first category of objects identified above is track based objects. All such objects are locked relative to the track and are generically known as bridge objects. The majority of objects in this category are bridges of one sort or another.

The second category of objects are track side objects. These are characterised in that they have a very different scale to the track to which they are attached. For example, in the embodiment of the game described here, the vehicles taking part in a race can typically travel at several thousands of kilometres per hour. A track side building having dimensions in the order of a few metres will therefore appear very small. For this reason, track side objects are displayed to a far larger scale so as to make a scene look reasonable.

Track side objects are added using the grid placement mechanism described above. When added they are initially placed in the centre of the track and can then be moved off the track in either direction. The movement of objects relative to the track is controlled by holding down the circle button 13 whilst pressing one of the arrow buttons 15. Track side objects are notionally categorised to be either track relative or ground relative. Track relative objects will in general be linked to the track side (e.g. a grandstand, or an advertising board). Ground relative objects will in general not be lined to the track (e.g. a tree or a building).

In many cases, buildings may be positioned at a track side such that part of the building overhangs the track. If this happens, collision between the building and the vehicle is not detected, and the vehicle continues as normal. This avoidance of collision detection is adopted because it may be the case that a small part of a building overhangs the track, and detection of a collision with such an overhang would make the game disproportionally difficult for a user. This technique also means that if a building is placed in the centre of the track, a vehicle will pass straight through the building.

The third category of objects identified above are collidables. One type of collidable object is a power up. There are two types of power up—a speed up power up and a health power up. A speed up power up is stored within a vehicle and can be used at a later stage in the game to obtain extra boost, thereby making the user more competitive. Strategic decisions must be taken to determine the optimum time at which the power up should be used. A health power up increases a user's longevity, by increasing the number of obstacles with which they may collide before the craft explodes.

Another collidable object is a Jumpbar. Such an object is placed on a segment of track using the aforementioned grid mechanism. During a race, a user colliding with a Jumpbar is propelled vertically off the track. This force, in combination with the forwardly acting force causing motion causes the vehicle to follow a parabolic path as an object acting under gravity in accordance with standard Newtonian mechanics.

The provision of Jumpbars can make a track easier or more difficult to race, depending on the position of the Jumpbar on the track, and the relative placement of other objects. For example, placing a Jumpbar near a bridge will require careful consideration by the user of the speed required such that the user does not collide with the bridge.

Collidable objects do not cover the entire width of a track segment. It is thus possible to give a user a choice as to whether or not to hit, and therefore use a collidable object. Such decisions can be difficult, as described above with regard to Jumpbars. Furthermore, two collidables may be placed side by side such that a user may either hit a powerup or a jumpbar—again a strategic decision must be taken by the user, thereby increasing the involvement of the game.

A further class of collidable objects are painting items. This mechanism is used to determine the texture that is to be applied to the track. During track creation a standard texture is used, but as mentioned above, the user is able to modify this texture should he so wish. To do this, the user again uses the grid view and selects any one of the four squares relating to the particular track segment. By navigating through the menu structure, the user is presented with a number of textures which he may then choose from and apply to the selected segment of track. Having made this decision, the user then moves forwards along the track using the up arrow button, thereby applying the chosen texture to the track.

In addition to the track textures described above, which serve a solely aesthetic purpose, a user may add surface effects to a track area. These effects are added using the grid mechanism described above, in the same way as a track texture. The effects include snow, dust and water. On colliding with a track section to which any of these effects has been applied, a vehicle's handling characteristics change in line with the way these effects would change real world driving conditions.

A speedup track effect may be added in the same way. On colliding with such an area of track the vehicle instantly gains speed. Such an effect may make a track easier or harder to follow depending on the positioning of the speedup track within the track geometry.

It should be noted that track effects and speedup track are placed a small distance above the track such that the existing track texture remains in place, but is overlaid with the texture of the effect. Furthermore, track paint effects are by default applied to a default width of track at the centre of the track. However, it is possible to adjust this width, and move the track paint effect to the left or right of the track such that only part of the track is affected by the effect. This makes it more important for a user to steer carefully along the track so as to avoid difficult driving conditions caused by for example dust or snow.

The final painting items are applied to barriers, not to the track. They are right barrier paint and left barrier paint items and allow alteration of barrier textures and colours as has been mentioned above. The mechanism is the same as for track textures and effects. A grid square is occupied for each segment for which the barrier paint is non-standard. Using the barrier paint functionality allows a user to paint barriers around a sharp bend in a bright colour, so as to act as a warning to users.

It was mentioned above that a user may add a corkscrew or “loop the loop” into a section of track by simply “driving” the track forward in the appropriate way. While such an effect provides a user with complete flexibility, and allows creation of a wide variety of tracks, it will be difficult, particularly for inexperienced users, to neatly create a corkscrew effect.

The editor module provides a solution to this problem by providing a corkscrew function which may be applied to a section of track of arbitrary length. The function applies a corkscrew of fixed and well defined geometry to the section of track. Addition of a corkscrew effect is very similar to the addition of painting items. That is, a user selects a cell in the grid display in the row equating to the segment where the corkscrew is to begin. On positioning the cursor within such a cell the user hits an appropriate button to begin corkscrew creation. The user then uses the forward arrow key to select a series of segments to which the effect will be applied. A corkscrew added using this method is illustrated in FIG. 14a, in which it can be seen that the editor module of the track generator component inserts a corkscrew effect by constantly changing the twist of the track along the length of the corkscrew.

It has been described above that each track segment has an associated twist angle. This twist angle specifies the amount of twist or banking that is to be applied to the forwardmost or leading edge of that segment. When inserting a corkscrew effect using the edit mode functionality, the user specifies an angle through which the track is to turn over the course of the corkscrew (e.g. 360° for a complete corkscrew). This angle is divided by the number of segments over which the corkscrew is to be applied, and the appropriate twist angle is stored alongside the vectors for each segment.

It will thus be appreciated that no additional data structures are needed to store a corkscrew on a given track. Instead the appropriate twist angle is stored for each track segment. However, in a preferred embodiment of the present invention, a flag is stored to indicate the start position of a corkscrew. A suitable icon is shown in the grid view of FIG. 14a. This flag allows a user to remove the corkscrew by simply deleting the icon, and also provides a visual indication of the position of the corkscrew while the user is manipulating the track using the grid view.

A further effect that may be added using the editor is a track split. Such an effect causes a new track to originate from a point in a previously established or current track. The split can be created so as to create a branch track on the right hand or left hand side of the current track. A split is inserted by selecting a cell in the row of the grid equating to the segment from where the split is to begin. Having selected an appropriate grid cell, the user can then traverse the hierarchy of menus to select the right or left split operation as desired. Upon selection of a right or left split in this way, the user is returned to the add track mode of the track generator component so that further track segments may be added to the track section which has been branched off from the main track. FIG. 14b shows a display of a track and a branch track that has been split from it.

In the add track mode, the user may intuitively angle the first segment of branch track and proceed to add and angle further segments as previously described. The user may rejoin the split track to the main track by navigating the end of the split track to overlap the main track, whereupon the track generator will link the split track to the main track as described below.

It has been described above that each track segment is defined using a position vector. As the branch track is driven forward, the distance between the position vector of its last segment and the position vectors of other track segments are compared. If the computed distance is less than a predetermined amount, the two tracks are joined. The barriers on each track are deleted so far as is necessary.

Having determined that the two tracks are to be joined, it is then necessary to determine how much of each track segment will be displayed. Referring to FIG. 14c there is illustrated a main track 30a and a branch track 30b. Segment S1 of the branch track 30b is sufficiently close to the segment S10 of the segment S10 of the main track 30a that the two tracks are to become joined. When joined, segment S1 of the branch track 30b should not be displayed at all as it is contained entirely within the main track 30a. Each of segments S2, S3 and S4 of the branch track 30b need only be rendered to the extent to which they are shaded, that is portions of these segments which do not overlap the main track 30a. Furthermore, the right hand barriers of segments S2, S3 and S4 are automatically set to a height of zero, as are the left hand barriers of segments S10, S11, S12, S13 and S14 of the main track 30a.

It will be appreciated that the functionality for joining portions of track described above with reference to the split track feature, is generally applicable, and may be used to join sections of a normally created track in order to form loops.

The edit time data format for a split therefore includes a flag indicating a segment from which the branch emanates, together with geometrical data in the described format for each segment. It is also necessary to store a flag for each segment involved in a join to identify how much of the segment should be displayed.

At edit time a split icon (as shown in FIG. 14b) is placed in a grid cell relating to the segment from which the branch emanates. The split icon is not needed to represent the split in any way but provides a one step operation for deleting the split by deleting the icon. Furthermore, the icon provides a convenient location indicator for the user.

This functionality allows a user to create two substantially parallel tracks, and add different features to each. For example, one track may comprise a large number of bends and surface water and dust making it more difficult, whilst the other may be relatively straight and contain a number of powerups. The user must make a choice as to which path to take.

The features of the editor module as hereinbefore and hereinafter described are all equally applicable to tracks which have been split from a main track, such that adding features to the split track is a process essentially the same as that described above using the grid view. It will thus be appreciated that a user may create splits from split tracks so that a complex series of tracks may be generated, requiring user experience to determine the optimum path through the series of tracks.

The editor module also provided the functionality mentioned above such that a user may affect the height of barriers on a particular area of track. A non-default barrier height for a segment occupies one cell of the grid row equating to that segment of track, and is specified in the same manner as described above with reference to the track texture and barrier texture effects. A user is able to select the barrier height value from a list of predefined height options displayed by means of a menu. This menu includes an option to specify that no barriers are included on a segment of track, which can make the game considerably more difficult as it is more likely that the user will leave the track.

The width of an area of track can also be changed using edit mode functionality. When created a track has a default width, but this is variable using methods similar to those described above.

When track is located adjacent the ground, it may be desirable to position the track underneath the ground, thereby adding dust or grass to the track so as to affect handling characteristics. The editor provides functionality such that a user may select a region of track and select to bury this track just under the surface of the terrain, so as to provide surface effects. In doing this, some parts of the track will remain visible. The user interface provided for use of this feature is similar to that described above.

A final category of effects provided by the editor module are classified as dynamic effects. That is the effect they have on the track changes as a race proceeds. A number of such effects are provided by an editor module in a preferred embodiment of the present invention, although only one dynamic effect may be applied to any segment. Dynamic effects are applied to segments and groups of segments using the grid view as described above.

One such dynamic effect makes the track invisible, that is barriers are displayed at its extremities, but the track surface itself is entirely see through. This allows a user to view the terrain below the track. Such an invisible track can have barriers removed using the barrier height adjustment mechanism described above, and this can make the game considerably more difficult as it will not be apparent where the track is leading, although track segments do exist.

Another dynamic effect is a track gap effect. This deletes one or more segments from the track so as to create a gap over which a user must jump. Providing a jumpbar as described above in advance of a track gap effect will make it easier for the user to cross the gap.

Only one of the dynamic effects mentioned above can be applied at any one track segment. Thus a third effect of normal track is supplied which will return an area of track which has been made invisible or has been deleted to its normal visible state.

The final dynamic effect is real time track deformation. Such an effect causes the track to move or “wobble” during play, making it much more difficult for a user to keep their vehicle or craft on the track surface. Fifteen types of deformation effect are provided as standard in the described embodiment of the present invention. The default option of no deformation therefore means that sixteen different deformation states are provided.

Each of these deformation effects is specified by a wave equation for displacement of point from rest:

displacement=cos 256(phase+(speed×time))×size (13)

where cos 256 is a function such that:

$$cos 256 ( n ) = cos ( \frac{π n}{256} ) ;$$

speed is the speed of the wave obtained from a lookup table as described below;

time is a global clock implemented by the software, ticking once for every displayed frame;

size is the amplitude of the modelled wave and is obtained from a lookup table as described below;

phase=((TrackIndex×PhaseInterval)+PhaseOffset) & 255;

TrackIndex, PhaseInterval and PhaseOffset are all obtained from a lookup table as described below; and

& a bitwise logical AND operation.

Different look up tables are provided for the left and right hand sides of the modelled of these is given below:

TABLE 1
Left Data

| Waveform No. | Phase Interval | Phase Offset | Speed | Size |
|---|---|---|---|---|
| 1 | 224 | 0 | 16 | 100 |
| 2 | 224 | 0 | 8 | 100 |
| 3 | 32 | 0 | 8 | 100 |
| 4 | 224 | 0 | 16 | 100 |
| 5 | 224 | 0 | 8 | 100 |
| 6 | 0 | 0 | 0 | 0 |
| 7 | 224 | 64 | 16 | 100 |
| 8 | 224 | 64 | 8 | 100 |
| 9 | 224 | 0 | 16 | 100 |
| 10 | 0 | 0 | 16 | 100 |
| 11 | 0 | 0 | 16 | 50 |
| 12 | 0 | 128 | 16 | 100 |
| 13 | 0 | 64 | 16 | 100 |
| 14 | 224 | 128 | 16 | 100 |
| 15 | 32 | 128 | 16 | 100 |

TABLE 2
Right Data

| Waveform No. | PhaseInterval | PhaseOffset | Speed | Size |
|---|---|---|---|---|
| 1 | 224 | 0 | 16 | 100 |
| 2 | 224 | 0 | 8 | 100 |
| 3 | 32 | 0 | 8 | 100 |
| 4 | 224 | 64 | 16 | 100 |
| 5 | 224 | 64 | 8 | 100 |
| 6 | 224 | 0 | 16 | 100 |
| 7 | 224 | 0 | 16 | 100 |
| 8 | 224 | 0 | 8 | 100 |
| 9 | 0 | 0 | 0 | 0 |
| 10 | 0 | 0 | 16 | 100 |
| 11 | 0 | 0 | 16 | 50 |
| 12 | 0 | 0 | 16 | 100 |
| 13 | 0 | 0 | 16 | 100 |
| 14 | 224 | 0 | 16 | 100 |
| 15 | 32 | 0 | 16 | 100 |

For a particular deformation effect, a user designing the track will select a waveform by choosing one of the fifteen predefined waveforms equating to the values given in Tables 1 and 2. These values are substituted into the equations for phase and displacement and applied to each track segment in turn to calculate its displacement. Such displacement may either be from side to side or up and down relative to the track. This placement is used to manipulate the co-ordinate pair representation of the segments and the deformed segments are then converted into a plurality of polygons and displayed in a conventional way. It will thus be appreciated that the deformation feature provided by the present invention completely renders a deformed track in real time, thereby adding considerable flexibility.

It will be appreciated that a user can make a track considerably more difficult by adding real time deformation effects to the track, as a user racing on the track will need to predict where the track will be when the vehicle is upon it.

It should be noted that all dynamic effects mentioned above are applied to a section of track in the same way as that previously described for barrier and texture effects.

It should be noted that up to four effects can be added to any segment of track using the grid view as described above. Combining effects can make a track more interesting or challenging when it is used as a basis for a race. For example, making a track section invisible and then adding a number of powerups will mean that a user can not see where the powerups are located. Similarly, using track paint effects such as dust, snow or water on invisible track will greatly add to the difficulty of the game as it will not be clear to the user where the handling characteristics of the vehicle will change in response to these effects.

Combining effects can also create “secret” sections of track. For example, a user may add a split to the main track, and then position the split track such that it is running above the main track at some vertical distance. By selecting the beginning of the split track, and causing it to be invisible, there is no way for a user to see that the split exists. Furthermore, a jumpbar may be provided adjacent the split so as to aid a user in reaching the secret track.

The operation of the joypad as used in the editor module will now be described by referring back to FIG. 13. Using the left arrow button 15 selects the contents of a slot. By holding down the circle button 13 and using the arrow buttons 15 a selected object may be moved between cells of the grid. Combining the move buttons with the bottom right shoulder button 17 will accelerate this move operation. By moving objects forward and backwards along the track, their position in display view is altered. In contrast, moving from left to right allows a user to tidy the grid display, while having no affect on the position of objects in the display.

If a split object is selected, using the bottom left shoulder button 19 together with the arrow keys 15 will move the track editor mode onto the split track, whereupon the grid view will relate to the split track and actions can then be performed on this split track. If a user wishes to leave the track editor mode, and return to the add track mode, this can be done using button 22. Button 23 displays a menu. The cross button 14 as applied to an empty cell will allow a user to add an object to that cell. When applied to a cell containing an object, the user may overwrite the current contents with a different object. The triangle button 12 deletes any object present in the currently selected cell. Tapping the square button 11 displays attributes of the object present in the cell and allows a user to perform appropriate manipulation of these attributes.

Once the square button 11 has been tapped, this takes the software into an adjust object mode, whereupon the buttons of the joypad assume different functionalities. The cross button 14 returns to the edit mode functionality described above, saving any changes that may have been made. The triangle button 12 cancels any changes that have been made and returns to the editor mode. The circle button 13 and square button 11 are used for amendment of attribute values appropriate to the object being edited.

Returning to the functionality of the edit mode, it should be noted that use of the arrow buttons 15 whilst the square button 11 is depressed will highlight a plurality of track segments. Once highlighted the software assumes a Region Edit mode configuration, where objects can be added to all selected track segments. For example, pressing the cross button 14 will change the contents of one cell of each of the grid rows relating to a selected segment. Thus it is possible to apply bridges or powerups to a number of track segments in one operation. Furthermore, track texture, paint, and dynamic effect objects outlined above may be applied to the selected region in a single operation, thereby avoiding the need for the specification of start and end points which are in this case taken to be at the start and end of the selected region respectively.

Further functionality is provided in region edit mode to alter the geometry of the track. Using the up and down arrow buttons 15 while in this mode will cause an incline to be applied to the selected track region. Similarly, using the right and left arrow buttons 15 will cause a bend to be inserted into the track. Using the bottom left and right shoulder buttons 17 and 19 will bank the region of track. All changes effected in region edit mode may be undone by use of the triangle button 12. The square button 11 returns the user to edit mode.

In all modes the operation of the top shoulder buttons and right analog stick control in affecting camera position and zoom remains the same as has been described above for the add track mode of the track generator.

It has been described in outline above that a generated track may be stored on a memory card. It has also been mentioned that the edit time data format is used for such data storage. It is necessary to store the various effects that have been applied to the track on the memory card. Such data is where appropriate stored in the on/off format described above.

At display time, it has been described that the track geometry is represented in terms of co-ordinate pairs. Many track effects are represented by state variables which are held for each track segment. One state variable includes details of the track nature and can take four values thus:

TABLE 3
Values for track state variable

| Characteristic | Value |
|---|---|
| Track Normal | 0 |
| Track Gap | 1 |
| Track Invisible | 2 |
| Track under terrain | 3 |

A further state variable takes values between 0 and 15 to represent which (if any) of the track deformation effects are applied to a track segment.

Separate state variables are held for each of the effects listed in table 4

TABLE 4
State variables.

Variable
Left Barrier Height
Right Barrier Height
Track width
Track paint
Surface paint effect
Speedup track
Left Barrier Paint
Right Barrier Paint

Track effects occupying only a single track segment are represented in display mode by use of a quadtree. Effects represented in this way are bridges, trackside objects, powerups and collidables.

A quadtree takes a plan view of a two dimensional area, and creates a hierarchical structure for the area such that the entire area must be considered only at a low resolution, while only a small part of the area need be considered in detail to determine the exact position of the object. Quadtrees are a well known technique, and will not be described further here. For a full description see Watt, Alan “3D Computer Graphics”, Addison Wesley, 1993.

The split effect are represented by special purpose flags, the format of which has been described above. It is not necessary to store specific split data in the display time format, as the display system need only know the location of each track segment, not specifically that it is part of a branch track.

Conversion between the edit time and display time formats is effected by use of a finite state machine (FSM). An FSM traverses the edit time data representation and updates state variables identified above as it experiences various data changes. One example of such a data conversion will now be presented. State variables having the default value are not shown for the sake of simplicity.

Data in edit time format for nine segments S1 to S9 will be represented thus:

| | |
|---|---|
| Left Barrier Height = 5 | S1 TO S2 |
| Left Barrier Height = 2 | S3 TO S6 |
| Left Barrier Texture = 2 | S3 TO S10 |
| Wobble = 2 | S4 TO S6 |
| Texture = 2 | S5 TO S10 |
| Invisible | S7 TO S9 |
| Right Barrier Height = 0 | S7 TO S10 |

The FSM begins with all state variables values set to default values. S1 sets left barrier height to 5. This is replaced with a value of 2 at S3, thus the left barrier height status variable for S1 and S2 is set to 5. S1 sets texture to 1, this is replaced by a texture of 2 at S5, thus the track texture status variable for S1, S2, S3 and S4 is set to 5. The process continues for all other effects to yield the following display time data:

TABLE 5
Display time data/

| Segment | Non Default Variables | Value |
|---|---|---|
| S1 | Left Barrier Height | 5 |
| S2 | Left Barrier Height | 5 |
| S3 | Left Barrier Height | 2 |
| S3 | Left Barrier Texture | 2 |
| S4 | Left Barrier Height | 2 |
| S4 | Left Barrier Texture | 2 |
| S4 | Wobble | 5 |
| S5 | Left Barrier Height | 2 |
| S5 | Left Barrier Texture | 2 |
| S5 | Wobble | 5 |
| S5 | Texture | 2 |
| S6 | Left Barrier Height | 2 |
| S6 | Left Barrier Texture | 2 |
| S6 | Wobble | 5 |
| S6 | Texture | 2 |
| S7 | Left Barrier Texture | 2 |
| S7 | Texture | 2 |
| S7 | Track Type | 2 |
| S7 | Right Barrier Height | 0 |
| S8 | Left Barrier Texture | 2 |
| S8 | Texture | 2 |
| S8 | Track Type | 2 |
| S8 | Right Barrier Height | 0 |
| S9 | Left Barrier Texture | 2 |
| S9 | Texture | 2 |
| S9 | Track Type | 2 |
| S9 | Right Barrier Height | 0 |
| S10 | Left Barrier Texture | 2 |
| S10 | Texture | 2 |
| S10 | Right Barrier Height | 0 |

Alongside data in the format shown in Table 5, there is provided a quadtree for locating bridges and similar objects. Translation of objects from the track in the edit time representation to the quadtree can be performed in a conventional way.

The representation shown in Table 5, together with the quadtree and the co-ordinate pair geometrical representation described above define the displayed tracks.

Splits in the track are stored separately and are linked to the geometry of the split track. Track segments are, in both representations, stored in a linear fashion. A split is a flag associated with a given track segment, providing an identifier of the first track segment that is to form part of the branch track emanating from that segment.

The track generator component also provides tutorial functionality to give a new user instruction on its use. This feature is of considerable importance given the complexity of operations that may be performed by the track generator. The tutorial is an entirely interactive component, and a screen from a tutorial is shown in FIG. 15.

Referring to FIG. 15 it can be seen that a screen identical to that of the track generator is displayed along with textual instructions at the bottom of the page, indicating what action is required from the user. In this case, the user is instructed to add ten segments of track. The tutorial program remains in this state until the action required from the user has been completed. Whilst waiting in this way, only buttons on the joypad required to perform the instructed operation will be enabled, with other buttons being disabled. In this case, the cross button for adding track is enabled, whilst all other buttons (such as arrow buttons for curving track segments) are disabled.

On satisfactory completion of the instructed action, the tutorial presents a further instruction to the user. By following these instructions all features of the track generator are demonstrated. Furthermore, the user creates an additional track, the format of which is predetermined by the tutorial, which may be used by the rack component of the game.

There are thus three different ways in which the track generator component is used: to generate a new track, to edit a user generated track, and to run a tutorial. In the embodiment of the invention described here, the thirty standard tracks cannot be edited by the track generator component, although it will be apparent to those skilled in the art that such functionality may be easily achieved given a track generator component as hereinbefore described.

It has been mentioned above, with reference to FIG. 3, that the explore component 28 allows a user to navigate about a predetermined space to determine where he would like the track to begin. An embodiment of this explore component will now be described in further detail.

This embodiment allows a user to select any point on a model of planet Earth. In order to produce the required model, data representing height points on the surface of the planet is stored in a database. The Earth is considered to be made up of six patches. Each one of these patches is in turn divided up into a grid of 64 tiles by 64 tiles, each tile in turn being divided into a grid of 128 cells by 128 cells. Thus the Earth is modelled as 402653184 individual cells, each cell equating to approximately one square kilometre of the Earth's surface. It will be appreciated that the patches will not be square, but will instead by deformed so as to fit together to form a sphere. Consequently the tiles making up each patch and the cells making up each tile will be similarly deformed.

For each individual cell, a height above mean sea level is stored. This height is taken to represent the height at the centre point of the cell. These heights create a dataset having a size of some 500 MB and allow the height of any point on the Earth's surface to be computed using an interpolation method functioning as described with reference to FIG. 16. Referring to FIG. 16, there is illustrated a square having vertices A′, B′, C′ and D′. Each vertex is assumed to be located centrally within a cell so that the height of that vertex can be accurately obtained.

It is desired to obtain a height value for a point X′ within the square A′B′C′D′. The point X′ is projected onto the line A′B′ to give x₁′, and onto the line C′D′ to give the point x₂′. The distance A′ₓ₁′, expressed as a fraction of A′, B′ is denoted d.

The height of the point x1′ can then be calculated by using an interpolation method. A suitable interpolation function is:

f(d)=3d²−2d³ (14)

Thus, the fractional distance d is input to equation (14), and the output, f(d), gives a interpolant by which the height of A′ should be multiplied. B′ should then be multiplied by 1−f(d) and the addition of these two multiples will give the height of the point x₁′.

That is:

height(x₁′)=f(d)×height(A′)+(1−f(d))×height(B′) (15)

where height ( ) denotes the height of its operand.

The distance C′x₂′ is also d. Thus:

height(x₂′)=f(d)×height(C′)+(1−f(d))×height(D′) (16)

Given the heights of x₁′ and x₂′, the height of X′ can be calculated using the interpolation function of equation (14) again in the orthogonal direction thus:

height(X′)=f(d′)×height(x₂′)+(1−f(d′))×height(x₁′) (17)

where d′ is the distance from line C′D′ to point X expressed as a fraction of the distance from the line C′D to the line A′B.

The interpolation function of equation 8 provides a more accurate interpolation than a straight forward linear interpolation. Furthermore, the function has a number of highly desirable properties. For example, referring to FIG. 17, equation (14) is plotted in the range 0≦x≦1. In this range, which will always be its input range given that distance is expressed fractionally as explained above, it can be seen that the function is symmetrical, such that f(1/2)=½.

The interpolation method as described above, therefore allows the height to be determined at any point on the Earth's surface, using an approximation based upon height values stored for each one kilometre square.

In order to select a starting point for track creation, a user is presented with a low resolution of planet Earth in the form of a spinning globe. The user may use a cursor to point at a particular point on this globe, whereupon a higher resolution image of the area surrounding that point is displayed.

This display is generated by taking the point which has been selected and obtaining height information for the cell containing the point. This point becomes the eye point in the higher resolution image.

Alternatively, a user may be presented with a short list of locations in which their track may begin. Such a short list is presented by means of a menu, and contains a number of locations chosen for their interesting landscape. Using this method, the eye point is determined by reading an eyepoint from a dataset linking menu items to eye points.

Using an eye point obtained as outlined above, a default view direction vector, and a default look point, the system can generate a view frustum for that eye point. This view frustum is projected onto the cells making up planet Earth and height information for each of these cells is obtained.

The view frustum defines what the eye is able to see. It is defined in terms of the eye point and look point identified above along with near and far clip planes. Field of view and aspect ratios are also defined and these dictate the width of view of the eye. The clip planes define the extremes of vision, and objects falling outside these clip planes are not displayed.

The vertices of the far clip plane, together with the eye point are projected on to the surface of the Earth. These five points are joined to form a polygon. The minimum bounding rectangle for this polygon is then calculated, and any cells falling within this bounding rectangle are taken into account when determining the form of the landscape that is to be displayed.

As explained above with reference to track smoothing, it is important that graphics in the near part of the view are displayed to a high standard, whilst graphics in the distance can be shown at a lower standard. Thus, it is necessary to divide areas proximate the eye point into a large number of polygons for rendering, whilst areas distant from the eye point may be converted to a smaller number of polygons so as to save processing and memory power, whilst not noticeably deteriorating the user's impression of the world. Decisions as to how many polygons should be used can be made using a detail look up table equating distance from eye position to object to a detail level.

For each polygon vertex, its height is determined using the interpolation method described above. Polygons created in this way are then subject to a perspective projection transformation to create a realistic display.

Such a perspective projection transformation involves creating a view frustum having the form of a truncated pyramid of rectangular cross section. The truncated apex of the pyramid represents the eye point. In addition there are also specified aspect ratio and field of view angles to specify the rectangular cross section and divergence of the pyramid respectively. Perspective projection transformations are well known and will not be described in further detail here. For a more detailed description see Angel, Edward “Interactive Computer Graphics: A top-down approach with OpenGL”, Addison Wesley, 1997.

Having generated a plurality of polygons, it is then necessary to apply textures to the polygons to create a realistic world. For example, land near the sea will often be a sandy beach, whilst high mountains will often be snow capped. This information is generated using a procedural texture.

By using lookup tables relating various cells and tiles to various landforms, approximate colour information for that area can be obtained. For example, an area of desert will have a generally sandy colour, while an area of rainforest will have a generally green colour and the sea will be blue. Furthermore, there is provided a low resolution map, indicating the height of the snow line in various cells and tiles, so as to calculate which polygons should be coloured so as to resemble snow. Furthermore, steep changes in height are usually rocky. Therefore, the procedural texture algorithm notices steep slopes and colours them as rocks. However, rock colour varies on different parts of the Earth, and accordingly a dataset is provided giving appropriate rock colours for different areas.

Having determined the nature of the surface, (e.g. snow, rock, sand, grass etc) the procedural texture algorithm has enough information to determine a base colour for each polygon with reasonable accuracy. However, filling complete polygons, even if relatively small, with a single colour will yield an unrealistic landscape. For this reason, it is necessary to take these base colours, and apply a noise generation algorithm thereto in order to create more accurate realistic landscapes. A suitable form for such a noise generator would be a Perlin noise function. Such functions are well known. Furthermore, a fractal based method may be used to add roughness to the created surface to improve its realism.

Thus, the described embodiment of the present invention provides an on-the-fly procedural texturing algorithm. Landscapes generated using this algorithm may be further enhanced by the addition of bitmap data. For example a bitmap representing a field of corn may be applied to an area. Similarly a number of tree bitmaps may be added to create forests. Tree density data for various parts of the Earth may be stored alongside the data outlined above.

Once the user has selected an eye point and a high resolution image of the surrounding landscape has been displayed, the user is able to move the eye point through the image so as to specify the track start point with greater accuracy. As the eye point is altered in space by use of the joypad controls, it will be necessary to obtain information about other parts of the model of the planet Earth.

In order to allow this movement to progress smoothly, the software is created such that the direction in which the eyepoint is moving is used to look ahead so that model data, and procedural texture data can be read in advance of its being needed. When this data is obtained, the principles of creating polygons and rendering them appropriately is carried out as described above.

In one embodiment of the present invention, the Explorer component and track generator component work together to ensure that at no time should the track go below ground level. This is achieved by taking a current height and ensuring that it is greater than land height by a predetermined distance. This process is now described, with reference to FIG. 18.

Here, there is illustrated a track 33 proceeding adjacent a continuous landform 34. A point denoted C, represents the centre of the modelled Earth, and it is to be noted that the figure is not to scale, since the distance between C and the surface of the Earth is of the order of 6.4×10⁶, and the track is clearly of far shorter length.

In order to determine whether or not a segment of track falls below ground level, the magnitudes of the position vector of the track segment and of the vector passing from the point C to the Earth's surface are compared. In fact, it is desired that a track segment must always pass over the Earth at a distance ε from the Earth's surface. Therefore, given two vectors, a vector E being a vector from C to Earth, and a vector T being the vector from C to the track such that the two vectors have same direction, the software performs the following check to ensure that each segment of track is above ground:

|T|−|L|≧ε (18)

where:

|T| is the magnitude of vector T;

|L| is the magnitude of vector L; and

ε is the minimum distance at which the track must pass over the Earth.

If the inequality of equation (18) is not satisfied, the track must be adjusted, such that it does pass over the Earth at a distance greater than or equal to ε. Thus, if a track is downwardly inclined, such that it becomes too close to the Earth, the track is allowed to pass as close to the earth as ε, and is then flattened to continue to pass at a distance of ε. Such an adjustment may alter the length of track. If this takes place, the track is extended to the nearest multiple of 212 metres, that being the length of a single track segment.

Thus, considering the points illustrated in FIG. 18 it can be seen that

|T₁|−|L₁|>ε (19)

Resulting in no enforced track change, whilst:

|T₂|−|L₂|<ε (20)

Resulting in the illustrated track being altered so as to pass over the surface at a distance of ε.

Using the explorer module as described above a user may traverse the supplied model to select an interesting place in which a track may be placed. It may be that the track will be part land based and part sea or river based. In an alternative embodiment of the present invention, there is provided functionality such that the user is not forced to use a ground avoidance technique such as that described above but is instead free to cause the generated track to go underground or under the sea.

In a preferred embodiment of the present invention allowing such tunnelling, there is provided functionality such that track surface effects are automatically generated in response to the environment. For example, a track passing beneath the surface of the sea would be wet, and would therefore have a water effect applied to it. Similarly, a track passing underground may be dusty.

In an alternative embodiment of the present invention, the user is not presented with a model of planet Earth. Instead the user is provided with a choice of models of far smaller spaces, for example a selection of domestic environments. In this case the game can simulate an environment in which children are building a toy racing car track about the house, but with far greater freedom than would be provided by a traditional game operating in the real world. For example, the track may be caused to go through a bath full of water, whereupon it becomes wet, in a similar way to the effect used for the sea as described above.

It will be appreciated that other suitable environments could be modelled and provided as a basis for track creation.

It will also be appreciated that a track need not be based in a pre-generated environment. Instead, a track is created in an arbitrary blank landscape. Track creation proceeds as hereinbefore described, although as the space is flat, there is no need for the ground avoidance method described above.

Having created a track in such a blank landscape, the user may then use an additional landscape editor, to add geographical features to the landscape and alter the landscape height to create mountains, valleys, canyons, rivers and other geographical features. Such an approach gives considerably more flexibility to a user, removing constraints implied by the natural landscape.

In yet a further embodiment, the track is created in a blank space, and software is provided whereby a landscape is generated to fit about the track created by the user.

In either of these alternative embodiments, it will be appreciated that the populated landscape may be modelled and navigated in the same way as the first embodiment described above.

Referring back to FIG. 3, it can be seen that embodiments of both the track generator component 27 and the explore world component 28 have been presented in some detail. Rules of the game for the game component 26 have also been described. Further detail about the modelling processes involved during operation of a game according to the present invention will now be described.

The world generator described above generally models all interactions in terms of conventional Newtonian physics. That is objects are subject to forces, and accelerate if the result of these forces in non zero. A track motor is implemented to model the operation of a vehicle on the track. This models a propulsion force given to the vehicle, and ensures that a smooth movement of the vehicle over the track is achieved.

The vehicle being moved across the track may be a hovercraft travelling a small distance above the surface of the track. The vehicle is modelled as a point travelling along the track and the hovercraft is modelled at this point. The modelling uses a Bezier Patch model to render the craft. This model is stored in memory. The point which moves across the surface of the track is modelled to have a steering force moving from left to right relative the track, and a propulsion force acting a forward direction. Other forces such as friction are also modelled.

A high level portion of the track motor determines the distance that the craft will travel using a predetermined thrust. This distance is then applied to the point, such that the point moves smoothly across the track surface in the desired direction. For this purpose, the track is represented as a triangle mesh. At any time the position of the point within a triangle of this mesh is known. The point is moved in the direction of propulsion until it reaches a point of intersection with another triangle, and the process continues as the point moves across the surface of the track.

Techniques for modelling object interactions in computer games are well known, and will therefore not be described in further detail here. It is noted however, that in a preferred embodiment of the present invention, the vehicle is modelled to move smoothly, and bounces upon returning to the track.

The software also takes into account the handling characteristics caused by various track effects which have been described above such as snow and dust. When modelling such effects a balance has to be achieved between accurate modelling of the forces acting on the vehicle and a playable game. For example, a vehicle hitting dust at thousands of miles per hour would not be controllable, thereby yielding an unplayable game. For this reason greater emphasis is placed on ensuring that the game is playable than absolute modelling of physical interactions.

A vehicle colliding with a barrier will be damaged. This is reflected by a user being given a number of shields which are depleted on each collision. Furthermore, should a user leave the track, he will fall under gravity. It may be that the vehicle can be controlled so as to bring it back onto the track without damage. Alternatively, the vehicle may collide with the ground and suffer considerable damage.

The physical forces acting on a vehicle are modelled differently depending on whether or not the vehicle is above the surface of the track. If the vehicle is not above the track, it is modelled as falling under the control of the explorer component.

In a race including opponents provided by the game, opponents generated by the software have artificial intelligence such that they may instantly compete against a user on any track. In order to compete in this way the software will perform a single pass through the data structures representing the track to identify the location of features such as gaps, splits and power ups and is then ready to compete at one of a number of intelligence levels with the user. The level of intelligence is set by the front end of the software as described above.

Software generated opponents are given the ability to follow the track by use of a simple algorithm considering the current location of the opposition vehicle and the forthcoming track geometry. By using a look ahead approach to determine the geometry of the track ahead and combining that with the track feature information the game can obtain the information necessary to provide realistic opponents.

At race time, the track is represented as a plurality of vector pairs, one item of each pair defining a point on the left hand side of the track, while the other item of the pair defines the right hand side of the track. It is necessary for the artificial intelligence system to appreciate this track geometry and identify for example, the location of curved areas of track.

Referring now to FIG. 19, there is illustrated a track comprised of a number of segments. The right hand co-ordinates of leading edge of segments S100, S101 are labelled a₁ and a₂ respectively. A vector v₁ defined between a₁ and a₂ can be easily calculated by:

v₁=a₂−a₁ (21)

Similar vectors, v₂ . . . vₙ can be calculated and this set of vectors define the right hand side of the track.

Taking the scalar (or dot) product between two of these vectors will provide an indication of the way in which the track is proceeding. For example, as track segments S101, S102 and S103 are all arranged in a straight ahead direction, the scalar product of vectors v₁ and v₂ will be 1.

In contrast, track segments S103 and S104 are arranged in a curved relationship, and the scalar product of vectors v₄ and v₅ will be less than one. The scalar product thus provides a useful indication of bends in a track, together with an indication of the location of such bends.

In practice, scalar products are not calculated in the localised manner described above, but are instead averaged over a number of track segments. For example, in the configuration illustrated in FIG. 20, the track proceeds in a generally straight ahead direction, although there is a bend. Localised scalar products will yield 1 for the straight ahead section A, less than 1 of the convex curve area B, more than 1 for the concave curve area C and 1 for the straight ahead section D. Thus averaging all these values will yield a value approximately equal to one, indicating the generally straightforward nature of this track configuration.

Given this averaged scalar product information, the software has a good idea of where the vehicle should be positioned, based upon hard coded information about desired location of the vehicle on a track of predetermined geometry. For example, in the example of FIG. 19, being a simple curve, the vehicle should be located at the apex of the bend so as to minimise distance travelled. In the example of FIG. 20, the optimum path is shown by a line L1. Thus, the software is coded such that an area of track having an averaged scalar product of about 1, is navigated centrally as shown by L1.

Thus, using simple vector geometry the artificial intelligence provided can determine the nature of the track and determine an optimum path that should be followed over this track.

Having decided on such a path, variation may be necessary to react to specific details. For example, if a curved area of track is provided with dust at its apex, it may be more desirable to follow a path towards the outside of the curve. The artificial intelligence mechanism is aware of the effects of the various track surfaces and acts to follow a path which chooses the most favourable effect.

The decisions described above are all taken by a high level artificial intelligence system. This system makes function calls to a low level system which is responsible for implementation of the decisions in terms of vehicle movements on the track.

The artificial intelligence system further takes into account the position of splits and gaps in the track. For example, on approaching a gap in the track (which has been located by the initial pass through the data structures representing the track) the vehicle must be positioned on the track, and face in a predetermined direction such that it is able to overcome the gap. The vehicle must also have a predetermined amount of thrust to ensure that it will fly for long enough before returning to the track.

It was mentioned above that the user can vary the expertise with which the provided opponents race. This expertise may be varied by changing the length of track over which the opponent looks ahead, and also by the expertise shown in dealing with various track surface effects. By varying the distance of look ahead, the impression of forthcoming track held by the opponent is varied considerably.

At a given time in either the race or track generator modes of the game, it will be apparent that a large quantity of processing power is required to correctly display the desired image. Several thousand operations of this nature can take considerable time to carry out, even when using state of the art processing power.

It has been mentioned above that objects positioned distant from the eye point are displayed at a relatively low level of detail, while those near the eye point are displayed at a higher level of detail. This technique reduces the rendering required to display distant objects.

A preferred embodiment of the present invention provides means for ensuring that the required vector operations can be completed within the necessary time scale, which is defined by the frame rate at which the game is operating. The means provided dynamically reduces detail to a level such that the necessary operations can be completed in the time available. The detail reduction mechanism uses three techniques to reduce the number of polygons that need be rendered. First, the far clip plane is moved inwards, so as to reduce the number of objects that need to be rendered. Second, the quality of rendering is reduced so that each object is split into a smaller number of triangles. Such a technique is applied to both the track and the world in which the track is located. Third, the quality of the texture information may be reduced to further reduce the rendering workload. It should be noted that these three quantities are concurrently changed to reduce detail, and that minimum detail levels are provided by the software, so as to ensure that the display looks acceptable.

An example of a preferred detail management system using the above detail reduction mechanism will now de described above. Computer games consoles typically use a standard video coding system. In Europe this is often Phase Alternation Line (PAL), while in other regions such as the USA it is often the National Television Standards Committee (NTSC) standard. Such standards define maximum frame rates. In the case of PAL the display is updated fifty times per second, whilst in the case of NTSC the display is updated sixty times per second.

Assuming a game operating under a PAL coding system and at a frame rate of 25 frames per second (fps), the display will be updated twice in each frame. All necessary rendering must be completed in the time for one frame, which is the time for two refreshes, that is one-twenty-fifth of a second. Failure to maintain updates at this rate will result in a sub-optimal display.

A timer is used to calculate the time between two subsequent renderings of a point on the display. If this time is greater than one-twenty-fifth of a second, it is necessary to reduce detail, which may be achieved by reducing all three properties identified above by a predetermined amount. Having done this, the timer again measures time between subsequent rendering. If this time is again too great, the detail level is further reduced.

If a situation is reached whereby the time between subsequent renderings is faster than required, the detail level may be increased, by reversing the steps outlined above.

Ideally, the time between subsequent renderings will be approximately as desired (one-twenty-fifth of a second in this example) and no reduction or enhancement will be necessary.

Referring back to FIG. 11a, an example of a track profile is shown. It is to be appreciated that this is an example profile only and other profiles may be implemented in a game according to the present invention. For example, a U-shaped profile allowing vehicles to travel in sideways orientation, as well as in an upright orientation may be implemented as may a tunnel profile.

The embodiments of the present invention described above have been implemented using a combination of the well known C and C++ programming languages. Additionally, in order to enhance performance, some vector graphics routines have been written in the low level assembly language of the stand alone vector graphics processor of the emotion engine (shown in FIG. 1). This low level coding ensures that optimum code is executed, avoiding the possibility of a compiler generating code having non-optimal properties, thereby diminishing the benefit achieved by using the standalone vector graphics processor. It will be apparent to those skilled in the art that other programming languages may be used for implementation.

Although the embodiment described above is implemented to operate of the PlayStation.2 games console it will be appreciated by those skilled in the art that the entire embodiment may be easily converted to run on a standard desktop personal computer or alternatively on another games console. Furthermore, it will be appreciated that the features as exemplified by the described embodiments, need not be limited to the game described above, but are instead widely applicable in a range of computer entertainment applications.

What is claimed is:

1. A method for generating a representation of a track which is to be followed through a virtual space, wherein a path is steered through the space, track path data representing the path is stored, and the track is established to follow that path.

2. A method according to claim 1, wherein a portion of a previously established track from which a branch track is to be established is selected, a branch track path is steered through the space from the selected portion of the previously established track, track path data representing the branch track path is stored, and the branch track is established to follow that branch track path.

3. A method according to claim 1, wherein if a path is steered which comes within a predetermined distance of a previously established track, updated track path data is generated and stored which represents a junction with the previously established track, and the track is established to include that junction.

4. A method according to claim 1, wherein the track is established in the form of a series of elementary segments spaced apart along the path.

5. A method according to claim 4, wherein the elementary segments have a generally rectangular shape.

6. A method according to claim 4, wherein the shape of an elementary segment is adjustable so as to create bend in the track.

7. A method according to claim 6, wherein bend is defined in terms of an angle between an elementary segment and the immediately preceding elementary segment in the track.

8. A method according to claim 7, wherein the angle between successive elementary segments is selectable and a selected angle is maintained between successive elementary segments until a different angle is selected.

9. A method according to claim 4, wherein the shape of each segment may be changed so as to twist the track about the direction of the path.

10. A method according to claim 1, wherein track path data is stored as a plurality of path direction vectors.

11. A method according to claim 10, wherein each stored path direction vector is stored with an associated position vector, each position vector defining a start location for a corresponding path direction vector.

12. A method according to claim 10, wherein the track path data stored includes a twist angle representing an angle of twist about the path direction vector.

13. A method according to claim 1, wherein the generated track is displayed on a computer screen.

14. A method according to claim 1, wherein the track is defined by first and second sets of co-ordinates, and members of each set are linked so as to define first and second sides for the track.

15. A method according to claim 4, wherein the track is defined by first and second sets of co-ordinates, and members of each set are linked so as to define first and second sides for the track and each segment is represented by a pair of co-ordinates, a first member of the pair being a member of the first set and a second member of the pair being a member of the second set of co-ordinates.

16. A method according to claim 14, wherein a plurality of members of at least one set of co-ordinates are input to an interpolation algorithm, operative to smooth the representation of the track edge to which the said at least one set relates.

17. A method according to claim 16, wherein the interpolation algorithm uses non-linear interpolation.

18. A method according to claim 17, wherein the interpolation algorithm uses cubic interpolation.

19. A method according to claim 18, wherein the interpolation algorithm is iterative.

20. A method according to claim 18, wherein four adjacent co-ordinates from the at least one set are input to the interpolation algorithm.

21. A method according to claim 20, wherein the interpolation algorithm generates a point B′ approximately according to the equation:
B′=wₐA+w_{b}B+w_{c}C+w_{d}D
where: A, B, C and D a re four adjacent co-ordinates from the first or second set of co-ordinates; B′ is a point in the interval BC, and wₐ w_{b} w_{c} w_{d} are weights applied to points A B C and D respectively, calculated such that
$$\begin{matrix}{w}_{a} = \frac{1 - 3 t + 3 {t}^{2} - {t}^{3}}{6} ; ; & {w}_{b} = \frac{4 - 6 {t}^{2} + 3 {t}^{3}}{6} ; \\ {w}_{c} = \frac{1 + 3 t + 3 {t}^{2} - 3 {t}^{3}}{6} ; & {w}_{d} = \frac{{t}^{3}}{6} ;\end{matrix}$$
where t is in the range 0 to 1.

22. A method according to claim 13, wherein the display is presented as viewed from a predetermined camera position within the virtual space.

23. A method according to claim 22, wherein the camera position is displaceable relative to the virtual space.

24. A method according to claim 22, wherein the camera field of view is adjustable.

25. A method according to claim 23, wherein as the path is steered through the space the camera is positioned to present a representation of the developing path.

26. A method according to claim 13, wherein the generated track is displayed in the form of a plurality of polygons.

27. A method according claim 22, wherein the generated track is displayed in the form of a plurality of polygons, portions of the generated track within a predetermined distance of the camera are displayed using a larger number of polygons than portions of the generated track further away from the camera.

28. A method according to claim 1, wherein the virtual space is a model of planet Earth.

29. A method according to claim 28, wherein the model of planet Earth comprises height values equating to heights at different points on planet earth.

30. A method according to claim 29, wherein the model of planet Earth models the Earth as a number of cells.

31. A method according to claim 30, wherein the Earth is represented by six patches, each patch is split up into a grid of 64 tiles by 64 tiles, each tile is divided up into 128 cells by 128 cells, and a height value is stored for each cell.

32. A method according to claim 31, wherein the stored height value represents a height at a vertex of the cell.

33. A method according to claim 29, wherein an interpolation algorithm is used to determine the height at a point on the model of planet Earth for which no value is stored.

34. A method according to claim 33, wherein the interpolation algorithm is non-linear.

35. A method according to claim 34, wherein a height value for a point P is determined by interpolating between two points A and B using an equation:
f(d)=3d²−2d³
where: d is a fraction defined as distance(AP)/distande(AB); f(d) is the interpolant for point A; and 1−f(d) is the interpolant for point B.

36. A method according to claim 1, wherein the virtual space is a model of a domestic environment.

37. A method according to claim 1, wherein the virtual space is initially featureless.

38. A method according to claim 37, wherein objects may be added to the virtual space.

39. A method according to claim 37, wherein objects are automatically added to the virtual space so as to fit about the generated track.

40. A method according to claim 1, wherein calculations are performed to ensure that the path remains on a predetermined side of a boundary within the virtual world.

41. A method according to claim 40, wherein a first vector is defined from the centre of a spherical co-ordinate system to a point on the path, a second vector is defined from the centre of the spherical co-ordinate system to a point on the boundary within the virtual world such that said first and second vectors each have the same direction, and the magnitudes of the first and second vectors are compared to determine whether the path remains on a predetermined side of the boundary within the virtual world.

42. A method according to claim 1, wherein the track path data and the virtual world are displayed on a computer display using a plurality of polygons, and the display is subject to a perspective projection view transformation, defined by an aspect ratio, a field of view angle, a camera position and near and far clip planes.

43. A method according to claim 1, wherein the number of polygons to be displayed is controlled so as to ensure that the necessary calculations can be completed between two temporally adjacent display frames.

44. A method according to claim 43, wherein the far clip plane is moved so as to control the distance that the camera may see, and therefore control the number of polygons to be displayed.

45. A method according to claim 43, wherein the number of polygons used to display a given display area is varied.

46. A method according to claim 42, wherein a timer is operated to calculate the time between two successive updates and if the calculated time is greater than the time for each frame, the number of polygons is reduced.

47. A method according to claim 42, wherein a timer is operated to calculate the time between two successive updates and if the calculated time is less than the time for each frame, the number of polygons is increased.

48. A method according to claim 1, wherein the method is implemented by a computer apparatus.

49. A method according to claim 48, wherein the computer apparatus is a personal computer or games console

50. A method according to claim 48, wherein the computer apparatus provides means for storing track path data on a non volatile storage device.

51. A method according to claim 50, wherein the storage is effected across a computer network.

52. A method according to claim 51, wherein the computer network is the Internet.

53. A computer program for carrying out a method according claim 1.

54. A carrier medium carrying computer readable code means for causing a computer to execute procedure according to claim 1.

55. A carrier medium according to claim 54, wherein the carrier medium is a DVD or CD ROM.

56. A carrier medium according to claim 54, wherein the carrier medium is a communications line.

57. An apparatus for carrying out a method according to claim 1.

58. A computer game embodying a method according to claim 1.

59. A track generator for generating a representation of a track which is to be followed through a virtual space, comprising means for steering a path through the space, means for storing track path data representing the path, and means for establishing the track to follow that path.

60. A method of manipulating a track to be followed, comprising selecting at least two points on the track, and applying a predetermined effect to the track between the two selected points.

61. A method according to claim 60, wherein the predetermined effect twists the track about the direction of the track.

62. A method according to claim 61, wherein an angle of twist is specified for the area of track between the two selected points, and appropriate twist angles are computed for parts of the track between those points.

63. A method according to claim 60, wherein the predetermined effect is a variable track deformation, said variable deformation being applied to the track at the time at which it is followed.

64. A method according to claim 63, wherein the variable track deformation is represented by means of a wave equation which is to be applied to the track between the two selected points.

65. A method according to claim 64, wherein the track has two sides, is defined by a set of co-ordinates at each side, and the wave equation is applied to each point along its length.

66. A method according to claim 64, wherein the wave equation has a general form:
displacement=cos M(phase+(speed×time))×size
where cos M is a function such that:
$$cos M ( n ) = cos ( \frac{π n}{M} ) ;$$
speed is the speed of the wave obtained from a lookup table;
time is a global clock implemented by the software;
size is the amplitude of the modelled wave;
phase=((TrackIndex×PhaseInterval)+PhaseOffset)mod A;
TrackIndex, PhaseInterval and PhaseOffset are all obtained from a lookup table as described below;
& is a bitwise logical AND operation; and
A is an integer.

67. A method according to claim 63, wherein data representing a plurality of real time deformations is stored and the user may select one of said plurality of real time deformations.

68. A method according to claim 60, wherein the predetermined effect comprises applying a texture to the surface of the track.

69. A method according to claim 68, wherein the effect is applied using a texture mapping algorithm

70. A method according to claim 68, wherein the applied texture causes the track to become transparent such that a virtual space through which the track passes is visible through the track.

71. A method according to claim 68, wherein the applied texture affects characteristics of an object following track.

72. A method according to claim 71, wherein the characteristics are affected so as to model a surface effect on the track.

73. A method according to claim 72, wherein the surface effect is snow, water or dust.

74. A method according to claim 60, wherein the effect comprises deleting the track to be followed between the two selected points.

75. A method according to claim 60, wherein the track to be manipulated is provided with a first barrier at a first side of the track, and a second barrier at a second side of the track.

76. A method according to claim 75, wherein the effect comprises applying a texture to a barrier.

77. A method according to claim 75, wherein the effect comprises adjusting the height of a barrier.

78. A method according to claim 60, wherein the effect comprises adding an object which may be moved to a position adjacent the track.

79. A method according to claim 60, wherein the effect comprises adding a feature to the track, such that an object following the track is affect by collision with the feature.

80. A method according to claim 79, wherein the feature causes an object colliding therewith to be given an additional propulsion force.

81. A method according to claim 60, wherein the method is implemented by a computer apparatus.

82. A method according to claim 81, wherein the computer apparatus is a personal computer or games console

83. A method of manipulating a track generated using a method according to claim 1, using a method according to claim 60.

84. A computer program for carrying out a method according to claim 60.

85. A carrier medium carrying computer readable code for causing a computer to execute procedure according to claim 60.

86. A carrier medium according to claim 85, wherein the carrier medium is a DVD or CD ROM.

87. A carrier medium according to claim 85, wherein the carrier medium is a communications line.

88. An apparatus for carrying out a method according to claim 60

89. A computer game embodying a method according to claim 60.

90. An apparatus for manipulating a track to be followed, comprising means for selecting at least two points on the track and means for applying a predetermined effect to the track between the two selected points.

91. A method for generating navigational instructions which if obeyed will allow a vehicle to follow a previously established track, wherein track geometry is determined by looking ahead along the track in the direction of travel, and instructions are derived in response to the determined track geometry.

92. A method according to claim 91, wherein the previously established track is defined by a plurality of co-ordinates.

93. A method according to claim 92, wherein the previously established track is defined by a first set of co-ordinates defining a first side of the track, and a second set of co-ordinates defining a second side of the track.

94. A method according to claim 93, wherein vectors are calculated between adjacent co-ordinates in each of the first and second sets.

95. A method according to claim 94, wherein the calculated vectors are used to determine forthcoming track geometry.

96. A method according to claim 95, wherein the scalar product is calculated for adjacent vectors on the first or second side of the track.

97. A method according to claim 96, wherein the scalar product is used to determine forthcoming track geometry.

98. A method according to claim 97, wherein the scalar product is averaged over a length of previously established track so as to more accurately determine the forthcoming track geometry.

99. A method according to claim 91, wherein the generated instructions are used to automatically navigate an object along the previously established track.

100. A method according to claim 91, wherein the navigational instructions are amended in response to a forthcoming track surface property.

101. A method according to claim 100, wherein the forthcoming track surface property is snow, water or dust.

102. A method according to claim 91, wherein the accuracy of the navigational instructions produced may be varied by a user.

103. A method according to claim 102, wherein the accuracy is varied by changing the length of forthcoming track that is taken into account when determining forthcoming track geometry.

104. A method according to claim 91, wherein the method is implemented by a computer apparatus.

105. A method according to claim 104, wherein the computer apparatus is a personal computer or games console

106. A computer program for carrying out a method according to claim 91.

107. A carrier medium carrying computer readable code for causing a computer to execute procedure according to claim 91.

108. A carrier medium according to claim 107, wherein the carrier medium is a DVD or CD ROM.

109. A carrier medium according to claim 107, wherein the carrier medium is a communications line.

110. An apparatus for carrying out a method according to claim 91.

111. An apparatus for generating navigational instructions defining a route following a previously established track, comprising means for determining forthcoming track geometry by looking ahead at forthcoming track, and means for deriving instructions in response to the determined track geometry.

112. A computer game wherein a vehicle is navigated over a previously established track using navigation instructions generated using a method according to claim 91.

113. A computer game comprising computer program code to cause a computer to execute procedure to operate a track generation method according to claim 1.

114. A computer game comprising computer program code to cause a computer to execute procedure to operate a track manipulation method according to claim 60.

115. A computer game comprising computer program code to cause a computer to execute procedure to operate a method of producing navigational instructions according to claim 91.

116. A carrier medium carrying a computer game according to claim 113.

117. A carrier medium carrying a computer game according to claim 114.

118. A carrier medium carrying a computer game according to claim 115.

119. A carrier medium according to claim 116, wherein the carrier medium is a DVD or CD ROM.

120. A carrier medium according to claim 117, wherein the carrier medium is a DVD or CD ROM.

121. A carrier medium according to claim 118, wherein the carrier medium is a DVD or CD ROM.
